(19) United States
(12) Patent Application Publication
(10) Pub. No.: US 2026/0074814 A1
(43) Pub. Date: Mar. 12, 2026

(54) APPARATUSES AND METHODS FOR RECEIVING OR PROVIDING A DIGITAL RADIO SIGNAL, AND DIGITAL RADIO SIGNALS

(71) Applicant: FRAUNHOFER-GESELLSCHAFT ZUR FOERDERUNG DER ANGEWANDTEN FORSCHUNG E.V., Muenchen (DE)

(72) Inventors: Alexander ZINK, Erlangen (DE); Markus PROSCH, Erlangen (DE); Guido LEISKER, Erlangen (DE); Olaf KORTE, Erlangen (DE); André HIRSCH, Erlangen (DE); Christos ALEWA, Erlangen (DE)

(21) Appl. No.: 19/177,952

(22) Filed: Apr. 14, 2025

Related U.S. Application Data
(63) Continuation of application No. PCT/EP2023/078360, filed on Oct. 12, 2023.

(30) Foreign Application Priority Data
Oct. 14, 2022 (DE) 10 2022 210 906.6

(51) Int. Cl. H04H 20/93; H04H 20/16

(52) U.S. Cl. CPC H04H 20/93; H04H 20/16

(57) ABSTRACT

Digital radio signals and apparatuses for providing or receiving such signals are described. A digital radio signal has one or more of a link type indicator, indicating the source of image content. A further digital radio signal has compressed SVG data. A further digital radio signal has an indicator indicating a presentation style for text information. A further digital radio signal has an indication of a target group for an information object. A further digital radio signal has signature data. A further digital radio signal has a predetermined start object identifier.

### CROSS-REFERENCE TO RELATED APPLICATIONS

This application is a continuation of copending International Application No. PCT/EP2023/078360, filed Oct. 12, 2023, which is incorporated herein by reference in its entirety, and additionally claims priority from German Application No. 102022210906.6, filed Oct. 14, 2022, which is also incorporated herein by reference in its entirety.

### TECHNICAL FIELD

Embodiments of the present invention relate to apparatuses and methods for receiving a digital radio signal, apparatuses and methods for providing a digital radio signal. Further embodiments relate to digital radio signals.

Some embodiments of the invention refer to Journaline and/or Digital Audio Broadcasting (DAB) and/or Digital Radio Mondiale (DRM). For example, the digital radio signal described herein may be conformant to Journaline and/or DAB and/or DRM.

Embodiments of the invention refer to devices, methods, and software for receiving, decoding, and playback of Journaline, particularly DAB, DRM, ATSC-DRM, and RDS receivers such as car radios/entertainment systems, desktop radios, smartphones, and tablets, TV devices and software for (creating and) coding of Journaline services. Further embodiments relate to devices, methods, and software for streaming radio services via a communication network such as an IP network.

### BACKGROUND OF THE INVENTION

Digital radio signals, such as DAB or DRM signals, may comprise information services, which carry content information such as text information or visual information. For example, Journaline provides a format for transmitting text information in such an information service.

It would be desirable to improve and/or increase the functionality of existing information services, e.g. in terms of one or more of an improved visual user experience, increased information content/usability of the signaled content, a low signaling overhead, targeting, verification, emergency warning functionality, low decoder complexity, or in terms of an improved tradeoff of any combination of these criteria.

### SUMMARY

Embodiments of a first aspect of the invention rely on the idea to provide multiple options for making image data available to a receiver of a digital radio signal, so that a receiver capable of presenting images, may present an image to a user. In particular, embodiments of the invention provide the possibility to indicate a source, from which the receiver may retrieve image data, to the receiver, thereby providing a high flexibility in the provision of image data. To this end, a link type indicator may be used to indicate, to which source a reference to image data refers. The sources may include an internal storage of the receiver, an external storage, to which the receiver may have access, and the digital radio signal. Accordingly, embodiments provide the possibility to embed image data in the digital radio signal, so that an image may be transmitted to the receiver without the requirement of additional connectivity of the receiver, e.g. to the internet. The different types of access allow a flexible usage of sources for image data.

Embodiments of the invention provide an apparatus for receiving a digital radio signal (or a data application decoder, e.g. a broadcast receiver) carrying text-based information content being divided into information objects, which are broadcasted in a data carousel manner, the apparatus configured to receive a predetermined information object containing text information; parse the predetermined information object with checking whether the predetermined information object comprises one or more data sections for supplementing the text information; if the predetermined information object comprises one or more data sections for supplementing the text information, check a type indicator of a predetermined data section if the type indicator indicates that the predetermined data section is of an image referencing type; if the predetermined data section is of the image referencing type, read a link type indicator and link information from the predetermined data section; and use the link information and the link type indicator so as to access image data with accessing the image data from a local memory comprised by the apparatus, if the link type indicator assumes one or more first states, accessing the image data from an external memory external to the apparatus, if the link type indicator assumes one or more second states, and accessing the image data from the digital radio signal (e.g., from the predetermined data section), if the link type indicator assumes one or more third states.

According to an embodiment, the image data may be embedded in the predetermined data section of the information object (e.g., a Journaline page), so that the image data is available together with the information object. In an alternative embodiment, the image data may be embedded in a further channel of the digital radio signal, e.g. another channel compared to the information object, e.g. a data channel, e.g. a channel dedicated for data transmission. In examples, the information objects, e.g. Journaline pages, may be restricted in size, so that a transmission of the image data in another channel may allow a transmission of larger image data files.

Further embodiments of the invention provide an apparatus for providing a digital radio signal carrying text-based information content being divided onto information objects, configured to provide the information objects in a data carousel manner, the apparatus configured to provide a predetermined information object containing text information, wherein the predetermined information object comprises one or more data sections (e.g., a page) for supplementing the text information, the apparatus configured to provide a predetermined information object containing text information by provide, in the predetermined information object, one or more data sections for supplementing the text information, and one or more data sections for supplementing the text information; provide, in the information object (e.g., in the predetermined data section) a predetermined data section, a type indicator of the predetermined data section which indicates that the predetermined data section is of an image referencing type; provide, in the predetermined data section, a link type indicator and link information, wherein the link information and the link type indicator indicate to access image data with accessing the image data from a local memory comprised by a receiver, if the link type indicator assumes one or more first states, accessing the image data from an external memory external to the receiver, if the link type indicator assumes one or more second states, and accessing the image data from the digital radio signal (e.g., from the predetermined data section), if the link type indicator assumes one or more third states.

Further embodiments of the invention provide a method for receiving a digital radio signal (or a data application decoder, e.g. a broadcast receiver) carrying text-based information content being divided into information objects, which are broadcasted in a data carousel manner, the method comprising: receive a predetermined information object containing text information; parse the predetermined information object with checking whether the predetermined information object comprises one or more data sections for supplementing the text information; if the predetermined information object comprises one or more data sections for supplementing the text information, check a type indicator of a predetermined data section if the type indicator indicates that the predetermined data section is of an image referencing type; if the predetermined data section is of the image referencing type, reads a link type indicator and link information from the predetermined data section; use the link information and the link type indicator so as to access image data with accessing the image data from a local memory (e.g., comprised by a receiver), if the link type indicator assumes one or more first states, accessing the image data from an external memory (e.g., external to a receiver), if the link type indicator assumes one or more second states, and accessing the image data from the digital radio signal (e.g., from the predetermined data section), if the link type indicator assumes one or more third states.

Further embodiments of the invention provide a method for providing a digital radio signal carrying text-based information content being divided onto information objects, configured to provide the information objects in a data carousel manner, the method comprising: provide a predetermined information object containing text information, wherein the predetermined information object comprises one or more data sections (e.g., a page) for supplementing the text information, the apparatus configured to provide a predetermined information object containing text information by provide, in the predetermined information object, one or more data sections for supplementing the text information, and one or more data sections for supplementing the text information; provide, in the information object (e.g., in the predetermined data section) a predetermined data section, a type indicator of the predetermined data section which indicates that the predetermined data section is of an image referencing type; provide, in the predetermined data section, a link type indicator and link information, wherein the link information and the link type indicator indicate to access image data with accessing the image data from a local memory comprised by a receiver, if the link type indicator assumes one or more first states, accessing the image data from an external memory external to the receiver, if the link type indicator assumes one or more second states, and accessing the image data from the digital radio signal (e.g., from the predetermined data section), if the link type indicator assumes one or more third states.

Embodiments of a second aspect of the invention rely on the idea to embed Scalable Vector Graphic (SVG) data in a digital radio signal carrying text information by compressing the SVG. In particular, the same compression/decompression algorithm is used for compressing the text information and the SVG data. Using the compression/decompression algorithm for text information and SVG data keeps the complexity for implementing the receiver low. Furthermore, in examples, e.g. Journaline, a size of the information objects (e.g., Journaline pages) may be restricted, e.g., to 4 kB. Compressing the SVG data allows for embedding larger SVG files into the information object while obeying the size limit.

Embodiments of the invention provide an apparatus for receiving a digital radio signal (or a data application decoder, e.g. a broadcast receiver) carrying text-based information content being divided onto information objects, which are broadcasted in a data carousel manner, the apparatus configured to receiving a predetermined information object containing text information; parse the predetermined information object with checking whether the predetermined information object comprises one or more data sections (e.g., a (Journaline) page) for supplementing the text information; if the predetermined information object comprises one or more data sections for supplementing the text information, check one or more indicators of a predetermined data section if the predetermined data section is for supplementing the texture information by an image represented by compressed SVG data; and use a predetermined decompression algorithm for decompressing the text information, and use the (e.g., same) predetermined decompression algorithm for decompressing the SVG data.

Further embodiments of the invention provide an apparatus for providing a digital radio signal carrying text-based information content being divided onto information objects, configured to provide the information objects in a data carousel manner, the apparatus configured to provide a predetermined information object containing text information, wherein the predetermined information object comprises one or more data sections (e.g., a page) for supplementing the text information, by using a predetermined compression algorithm for compressing SVG data, e.g. an image; and embedding the SVG data into a predetermined one of the data sections.

Further embodiments of the invention provide a method for receiving a digital radio signal (or a data application decoder, e.g. a broadcast receiver) carrying text-based information content being divided onto information objects, which are broadcasted in a data carousel manner, the method comprising: receiving a predetermined information object containing text information; parse the predetermined information object with checking whether the predetermined information object comprises one or more data sections (e.g., a (Journaline) page) for supplementing the text information; if the predetermined information object comprises one or more data sections for supplementing the text information, check one or more indicators of a predetermined data section if the predetermined data section is for supplementing the texture information by an image represented by compressed SVG data; use a predetermined decompression algorithm for decompressing the text information, and use the (e.g., same) predetermined decompression algorithm for decompressing the SVG data.

Further embodiments of the invention provide a method for providing a digital radio signal carrying text-based information content being divided onto information objects, configured to provide the information objects in a data carousel manner, the method comprising: provide a predetermined information object containing text information, wherein the predetermined information object comprises one or more data sections (e.g., a page) for supplementing the text information, by using a predetermined compression algorithm for compressing SVG data, e.g. an image; and embedding the SVG data into a predetermined one of the data sections.

Embodiments of a third aspect of the invention rely on the idea to signal an indicator of a presentation style for text information signaled in an information object of a digital radio signal. Accordingly, a receiver may select a presentation style based on the indicator, what allows to display information objects with their respective referenced presentation styles. The referencing of the presentation styles allows using the presentation style for multiple information objects, e.g., pages. Accordingly, styled information objects may be signaled with low signaling overhead. At the same time, by separating the text information and the presentation style, a high compatibility is provided, also with receivers that do not support the displaying of the presentation style.

Embodiments of the invention provide an apparatus for receiving a digital radio signal (or a data application decoder, e.g. a broadcast receiver) carrying text-based information content being divided onto information objects, which are broadcasted in a data carousel manner, the apparatus configured to: receiving a predetermined information object containing text information; parse the predetermined information object with checking whether the predetermined information object comprises one or more style type indicators; use one or more the style type indicators to select one or more or all predetermined presentation styles out of a plurality of different presentation styles of presenting the text information (e.g., the style type indicator is associated with, or points to, the one or more or all predetermined presentation styles); use the one or more or all predetermined presentation styles to present the text information on a display of the apparatus.

Further embodiments of the invention provide an apparatus for providing a digital radio signal carrying text-based information content being divided into information objects, configured to provide the information objects in a data carousel manner, the apparatus configured to provide a predetermined information object containing text information by providing, in the predetermined information object, one or more style type indicators, each being associated with one or more predetermined presentation styles out of a plurality of different (e.g., predetermined) presentation styles (e.g., being stored on a receiver).

Further embodiments of the invention provide a method for receiving a digital radio signal (or a data application decoder, e.g. a broadcast receiver) carrying text-based information content being divided onto information objects, which are broadcasted in a data carousel manner, the method comprising: receiving a predetermined information object containing text information; parse the predetermined information object with checking whether the predetermined information object comprises one or more style type indicators; use one or more the style type indicators to select one or more or all predetermined presentation styles out of a plurality of different presentation styles of presenting the text information (e.g., the style type indicator is associated with, or points to, the one or more or all predetermined presentation styles); use the one or more or all predetermined presentation styles to present the text information on a display.

Further embodiments of the invention provide a method for providing a digital radio signal carrying text-based information content being divided into information objects, configured to provide the information objects in a data carousel manner, the method comprising provide a predetermined information object containing text information by providing, in the predetermined information object, one or more style type indicators, each being associated with one or more predetermined presentation styles out of a plurality of different (e.g., predetermined) presentation styles (e.g., being stored on a receiver).

Embodiments according to a fourth aspect of the invention rely on the idea to signal labels for location references, which indicate a geographical location, such as a position or a region. Labels provide the advantage of providing semantics to the geographical locations, and further, they allow different location references to be distinguished from each other.

Embodiments of the invention provide an apparatus for receiving a digital radio signal, the digital radio signal comprising an information service (e.g., a Journaline service) carrying information content (e.g., text-based information for presentation, visual information for presentation) being distributed onto information objects, which are broadcasted in a data carousel manner. The apparatus is configured to: receive one of the information objects; and parse the information object to check, whether the information object comprises one or more location references, each indicating a geographical location (e.g., a geographical position or a geographical region), and if the information object comprises one or more location references, check whether the information object comprises, for one or more of the location references, respective labels (e.g., which indicate semantics of the location references).

Further embodiments of the invention provide an apparatus for providing a digital radio signal, the digital radio signal comprising an information service (e.g., a Journaline service) carrying information content (e.g., text-based information for presentation, visual information for presentation) being distributed onto information objects, the apparatus configured for providing the information objects in a data carousel manner, wherein the apparatus is configured to provide an information object by providing, in the information object, one or more location references, each indicating a geographical location (e.g., a geographical position or a geographical region), and for one or more of the location references, respective labels (e.g., which indicate semantics of the location references).

Further embodiments of the invention provide a method for receiving a digital radio signal, the digital radio signal comprising an information service (e.g., a Journaline service) carrying information content (e.g., text-based information for presentation, visual information for presentation) being distributed onto information objects, which are broadcasted in a data carousel manner, the method comprising: receive one of the information objects; parse the information object to check, whether the information object comprises one or more location references, each indicating a geographical location (e.g., a geographical position or a geographical region), and if the information object comprises one or more location references, check whether the information object comprises, for one or more of the location references, respective labels (e.g., which indicate semantics of the location references).

Further embodiments of the invention provide a method for providing a digital radio signal, the digital radio signal comprising an information service (e.g., a Journaline service) carrying information content (e.g., text-based information for presentation, visual information for presentation) being distributed onto information objects, the method comprising providing the information objects in a data carousel manner, the method comprising provide an information object by: providing, in the information object, one or more location references, each indicating a geographical location (e.g., a geographical position or a geographical region); and for one or more of the location references, respective labels (e.g., which indicate semantics of the location references).

Embodiments according to a fifth aspect of the invention rely on the idea to determine a relevance of information objects signaled in a digital radio signal based on a comparison between an information of a geographical region signaled in the information object and a geographical location of the receiver. Determining the relevance of the information object allows a filtering of the information signaled in the digital radio signal regarding its relevance to a user of the receiver.

Embodiments of the invention provide an apparatus for receiving a digital radio signal (e.g., Broadcast receiver), the digital radio signal comprising an information service (e.g., a Journaline service) carrying information content (e.g., text-based information for presentation, visual information for presentation) being distributed onto information objects, which are broadcasted in a data carousel manner. The apparatus is configured to: receive a predetermined information object; parse the predetermined information object to check, whether the predetermined information object comprises a data section comprising information about a geographical region to which the predetermined information object is relevant; if the predetermined information object comprises a data section comprising the information about the geographical region, (derive the target group information from the information service and) compare the information about the geographical region with an information about a geographic location of the apparatus to determine whether the predetermined information object is relevant to the apparatus (or a user of the apparatus).

Further embodiments of the invention provide an apparatus for providing a digital radio signal, the digital radio signal comprising an information service (e.g., a Journaline service) carrying information content (e.g., text-based information for presentation, visual information for presentation) being distributed onto information objects, the apparatus configured for providing the information objects in a data carousel manner, wherein the apparatus is configured to provide an information object by providing, in the information object, a data section comprising information about a geographical region to which indicates the predetermined information object is relevant.

Further embodiments of the invention provide a method for receiving a digital radio signal (e.g., Broadcast receiver), the digital radio signal comprising an information service (e.g., a Journaline service) carrying information content (e.g., text-based information for presentation, visual information for presentation) being distributed onto information objects, which are broadcasted in a data carousel manner, the method comprising: receive a predetermined information objects; parse the predetermined information object to check, whether the predetermined information object comprises a data section comprising information about a geographical region to which indicates the predetermined information object is relevant; if the predetermined information object comprises a data section comprising a the information about the geographical region, (derive the target group information from the information service and) compare the information about the geographical region with an information about a geographic location to determine whether the predetermined information object is relevant.

Further embodiments of the invention provide a method for providing a digital radio signal, the digital radio signal comprising an information service (e.g., a Journaline service) carrying information content (e.g., text-based information for presentation, visual information for presentation) being distributed onto information objects, the method comprising providing the information objects in a data carousel manner, the method comprising provide an information object by providing, in the information object, a data section comprising information about a geographical region to which indicates the predetermined information object is relevant.

Embodiments according to a sixth aspect of the invention rely on the idea to determine whether a receiver belongs to a target group of an information object signaled in a digital radio signal, that is, e.g., whether the information object is relevant to the receiver. Accordingly, embodiments allow a receiver to filter the information signaled in the digital radio signal regarding whether or not the receiver belongs to the target group of the information object.

Further embodiments of the invention provide an apparatus for receiving a digital radio signal (e.g., Broadcast receiver), the digital radio signal comprising an information service (e.g., a Journaline service) carrying information content (e.g., text-based information for presentation, visual information for presentation) being distributed onto information objects, which are broadcasted in a data carousel manner, wherein the apparatus is configured to: receive a predetermined information objects; parse the predetermined information object to check, whether the predetermined information object comprises a data section comprising a target group information which indicates a target group of the predetermined information object; if the predetermined information object comprises a data section comprising a target group information for the predetermined information object, (derive the target group information from the information service and) compare the target group information with an information about the apparatus to determine whether the apparatus belongs to the target group of the predetermined information object.

Further embodiments of the invention provide an apparatus for providing a digital radio signal, the digital radio signal comprising an information service (e.g., a Journaline service) carrying information content (e.g., text-based information for presentation, visual information for presentation) being distributed onto information objects, the apparatus configured for providing the information objects in a data carousel manner, wherein the apparatus is configured to provide an information object by providing, in the information object, a data section comprising a target group information which indicates a target group of the predetermined information object.

Further embodiments of the invention provide a method for receiving a digital radio signal (e.g., Broadcast receiver), the digital radio signal comprising an information service (e.g., a Journaline service) carrying information content (e.g., text-based information for presentation, visual information for presentation) being distributed onto information objects, which are broadcasted in a data carousel manner, wherein the method comprising: receive a predetermined information objects; parse the predetermined information object to check, whether the predetermined information object comprises a data section comprising a target group information which indicates a target group of the predetermined information object; if the predetermined information object comprises a data section comprising a target group information for the predetermined information object, (derive the target group information from the information service and) compare the target group information with a user-attributed information to determine whether the user belongs to the target group of the predetermined information object.

Further embodiments of the invention provide a method for providing a digital radio signal, the digital radio signal comprising an information service (e.g., a Journaline service) carrying information content (e.g., text-based information for presentation, visual information for presentation) being distributed onto information objects, the method comprising providing the information objects in a data carousel manner, the method comprising to provide an information object by providing, in the information object, a data section comprising a target group information which indicates a target group of the predetermined information object.

Embodiments according to a seventh aspect of the invention rely on the idea of providing signature data in an information object of a digital radio signal, the signature data allowing a verification of an integrity and/or an authenticity of the information object or a portion thereof. In particular, a predetermined section of the information object may be checked against the signature data, thereby allowing a verification of an integrity of the predetermined section and an authenticity of a source of the predetermined data section.

Embodiments of the invention provide an apparatus for receiving a digital radio signal (or a data application decoder, e.g. a broadcast receiver) carrying text-based information content being divided onto information objects, which are broadcasted in a data carousel manner, the apparatus configured to: receiving a predetermined information object containing text information; parse the predetermined information object with checking whether the predetermined information object comprises one or more signature data; if the predetermined information object comprises one or more signature data, check whether a predetermined section of the predetermined information object fits to a predetermined signature data of the one or more signature data in order to verify an integrity and/or an authenticity of the predetermined information object.

Further embodiments of the invention provide an apparatus for providing a digital radio signal carrying text-based information content being divided into information objects, configured to provide the information objects in a data carousel manner, the apparatus configured to provide a predetermined information object containing text information by, the apparatus configured to providing a predetermined information object containing text information by: creating signature data for a predetermined section of the predetermined information object; and providing the signature data in the predetermined information object.

Further embodiments of the invention provide a method for receiving a digital radio signal (or a data application decoder, e.g. a broadcast receiver) carrying text-based information content being divided onto information objects, which are broadcasted in a data carousel manner, the method comprising: receiving a predetermined information object containing text information; parse the predetermined information object with checking whether the predetermined information object comprises one or more signature data; if the predetermined information object comprises one or more signature data, check whether a predetermined section of the predetermined information object fits to a predetermined signature data of the one or more signature data in order to verify an integrity and/or an authenticity of the predetermined information object.

Further embodiments of the invention provide a method for providing a digital radio signal carrying text-based information content being divided into information objects, configured to provide the information objects in a data carousel manner, the apparatus configured to provide a predetermined information object containing text information by, the method comprising to providing a predetermined information object containing text information by: creating signature data for a predetermined section of the predetermined information object; and providing the signature data in the predetermined information object.

Embodiments of an eighth aspect of the invention rely on the idea of defining a predetermined object identifier. Usage of this predetermined object identifier as a start object identifier, which is signaled in a service signal or service channel of the digital radio signal may be detected by a receiver, allowing the receiver to react on the presence of the predetermined object identifier in the service signal. For example, the service signal may be a channel of the digital radio signal, which carries service information, e.g., not content. Information in the service signal may be retrieved reliably and/or fast. For example, the predetermined object identifier may relate to an information service carrying emergency information, so that the presence of the predetermined object identifier may indicate the presence of emergency information.

Embodiments of the invention provide an apparatus for receiving a digital radio signal (e.g., Broadcast receiver), the digital radio signal comprising a service signal comprising information about a plurality of services signaled in the digital radio signal, wherein digital radio signal comprises an information service (e.g., a Journaline service) carrying information content (e.g., text-based information for presentation, visual information for presentation) being distributed onto information objects, which are broadcasted in a data carousel manner, wherein each information object comprises an object identifier, and menu information objects comprise links to reference referenced information objects by pointing to the object identifier of the referenced information objects and the apparatus is configured to, based on starting from a start information object being identified by a start object identifier, navigate through information objects and present (e.g., to a user) information obtained from a currently selected information object. The apparatus is configured to: derive, from the service signal, a set of one or more start object identifiers (for respective start information objects, e.g., each of the start information objects is associated with a respective service of the plurality of services); check, whether one of the set of start object identifiers corresponds to a predetermined object identifier (e.g., having a predetermined value).

Further embodiments of the invention provide an apparatus for providing a digital radio signal (e.g., Broadcast receiver), the digital radio signal comprising a service signal comprising information about a plurality of services signaled in the digital radio signal, wherein digital radio signal comprises an information service (e.g., a Journaline service) carrying information content (e.g., text-based information for presentation, visual information for presentation) being distributed onto information objects, which are broadcasted in a data carousel manner, wherein each information object comprises an object identifier, and menu information objects comprise links to reference referenced information objects by pointing to the object identifier of the referenced information objects. The apparatus is configured to provide, in the service signal, a set of one or more start object identifiers (for respective start information objects, e.g., each of the start information objects is associated with a respective service of the plurality of services), wherein one of the set of start object identifiers corresponds to a predetermined object identifier (e.g., having a predetermined value, e.g., being associated with an information object having emergency information).

Further embodiments of the invention provide a method for receiving a digital radio signal (e.g., Broadcast receiver), the digital radio signal comprising a service signal comprising information about a plurality of services signaled in the digital radio signal, wherein digital radio signal comprises an information service (e.g., a Journaline service) carrying information content (e.g., text-based information for presentation, visual information for presentation) being distributed onto information objects, which are broadcasted in a data carousel manner, wherein each information object comprises an object identifier, and menu information objects comprise links to reference referenced information objects by pointing to the object identifier of the referenced information objects and the method comprising, based on starting from a start information object being identified by a start object identifier, navigate through information objects and present (e.g., to a user) information obtained from a currently selected information object. The method comprises: derive, from the service signal, a set of one or more start object identifiers (for respective start information objects, e.g., each of the start information objects is associated with a respective service of the plurality of services); check, whether one of the set of start object identifiers corresponds to a predetermined object identifier (e.g., having a predetermined value).

Further embodiments of the invention provide a method for providing a digital radio signal (e.g., Broadcast receiver), the digital radio signal comprising a service signal comprising information about a plurality of services signaled in the digital radio signal, wherein digital radio signal comprises an information service (e.g., a Journaline service) carrying information content (e.g., text-based information for presentation, visual information for presentation) being distributed onto information objects, which are broadcasted in a data carousel manner, each information object comprises an object identifier, and menu information objects comprise links to reference referenced information objects by pointing to the object identifier of the referenced information objects. The method comprises to provide, in the service signal, a set of one or more start object identifiers (for respective start information objects, e.g., each of the start information objects is associated with a respective service of the plurality of services), wherein one of the set of start object identifiers corresponds to a predetermined object identifier (e.g., having a predetermined value, e.g., being associated with an information object having emergency information).

Further embodiments provide a digital radio signal provided by any of the methods for providing a digital radio signal described above.

### BRIEF DESCRIPTION OF THE DRAWINGS

Embodiments of the present disclosure are described in more detail below with respect to the figures, among which:

FIG. 1 illustrates a digital radio signal, a receiver, and an apparatus for providing the digital radio signal according to an embodiment;

FIG. 2 illustrates a digital radio signal, a receiver according to an embodiment;

FIG. 3 illustrates a digital radio signal, a receiver according to an embodiment;

FIG. 4 illustrates a digital radio signal, a receiver according to an embodiment;

FIG. 5 illustrates a digital radio signal, a receiver according to an embodiment;

FIG. 6 illustrates a digital radio signal, a receiver according to an embodiment;

FIG. 7 illustrates a digital radio signal, a receiver according to an embodiment;

FIG. 8 illustrates a digital radio signal, a receiver according to an embodiment;

FIG. 9 illustrates a digital radio signal, a receiver according to an embodiment;

FIG. 10 illustrates a JML object according to an embodiment;

FIG. 11 illustrates a JML object with compressed content section according to an embodiment;

FIG. 12 illustrates a coding example for a data section continuation according to an embodiment;

FIG. 13 illustrates a coding example for a data section continuation according to a further embodiment; and

FIG. 14 illustrates data sections and a payload structure according to an embodiment.

### DETAILED DESCRIPTION OF THE INVENTION

Embodiments of the present invention are now described in more detail with reference to the accompanying drawings, in which the same or similar elements or elements that have the same or similar functionality have the same reference signs assigned or are identified with the same name. In the following description, a plurality of details is set forth to provide a thorough explanation of embodiments of the disclosure. However, it will be apparent to one skilled in the art that other embodiments may be implemented without these specific details. In addition, features of the different embodiments described herein may be combined with each other, unless specifically noted otherwise.

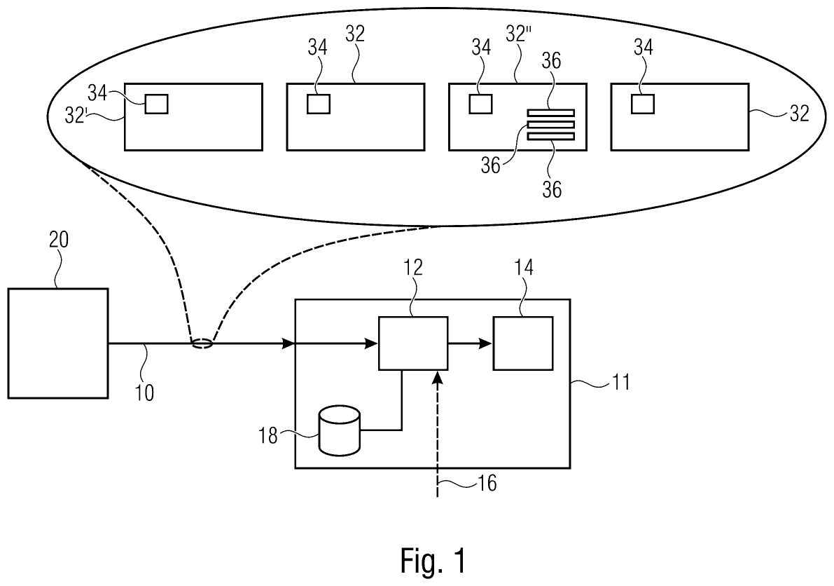

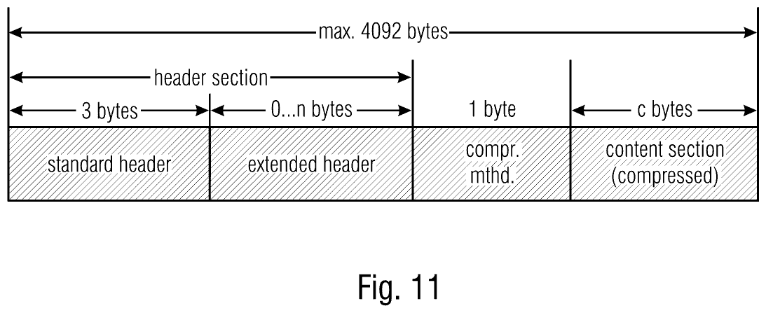

The following description starts with a brief introduction of a framework within which embodiments of the present invention may optionally be implemented. FIG. 1 illustrates an example of an apparatus 11 for receiving a digital radio signal, also referred to as receiver 11. FIG. 11 further illustrates examples of a digital radio signal 10 and of an apparatus 20 for providing a digital radio signal. Although illustrated in combination in FIG. 1, the receiver 11, the digital radio signal 10 and the apparatus 20 may be implemented individually from each other. Embodiments of the invention may optionally be implemented as described with respect to FIG. 1, but other embodiments do not necessarily implement features descried with respect to FIG. 1.

According to an embodiment, the digital radio signal 10 is conformant to Journaline and/or DAB and/or DRM. Accordingly, according to an embodiment, apparatus is configured for providing the digital radio signal 10 conformant to Journaline and/or DAB and/or DRM, and receiver 11 is conformant to Journaline and/or DAB and/or DRM.

According to an embodiment, the digital radio signal 10 is conformant to one or more of Journaline, DAB, DRM, ATSC-DRM, RDS. In examples, the digital radio signal is for radio service streaming via network, e.g., IP.

According to embodiments, the digital radio signal comprises, or is divided into, a plurality of information objects 32 (including information objects 32′, 32″), which are broadcasted in a data-carousel-like manner. That is, for example, information objects 32 may be repeatedly broadcasted. Each information object 32 may comprise an object identifier 34 (or object ID), which may allow receiver 11 to identify the respective information object 32 among the entirety of the information objects.

The information objects may be of different object types. For example, each information object 32 may carry information on its object type, which allows the receiver to identify the object type of the respective information object.

For example, the information objects 32 may include link objects or menu objects, e.g. object 32″ in FIG. 1, which includes links 36 referencing other information objects by means of their object identifiers 34.

The information objects 32 may further include a start object 32′, which may, for example, be identified by its object identifier 34, and which may be used by receiver 11 as a starting point for navigating through information objects 32. To this end, receiver may present information carried in the information objects 32 to a user, e.g. by presenting means 14 of the receiver, e.g. a display. E.g., receiver 11 may, e.g. based on links 36 of a link or menu object, present multiple options to a user. Based on a user input 16, receiver may select a subsequent information object for presentation to the user. E.g., receiver may scan the digital radio signal, in particular, the object identifiers 34 of received information objects 32, for the object identifier referenced by the selected link, and present the selected information object upon reception.

Accordingly, receiver 11 may comprise a data processor 12 for processing the information objects, and optionally a display 14 and an input interface 16 for receiving a user input.

Furthermore, as illustrated in FIG. 1, receiver 11 may optionally comprise a data storage 18 holding information, which may be referred to by information objects.

In more general terms, according to an embodiment, each information object 32 comprises an object ID 34, and menu information objects 32′, 32″ comprise links 36 to reference referenced information objects by pointing to the object ID of the referenced information object. According to this embodiment, the receiver 11 is configured to, based on starting from a start object ID, navigate through information objects and present to a user information obtained from a currently selected information objects.

The referencing between information objects may allow the receiver 11 to navigate through information objects without the need for an overall index of available information objects and their relationship to each other being made available upfront to the receiver.

According to an embodiment, receiver 11 navigates through information objects by presenting to a user information obtained from a currently selected information objects, and switching to a selected referenced information object.

According to an embodiment, receiver 11 is configured to select the selected referenced information object based on user input.

According to an embodiment, the predetermined information object comprises a header section and a data section, the data section containing the text information.

Features and details described with respect to FIG. 1 may optionally be implemented individually or in combination in any of the subsequently described embodiments.

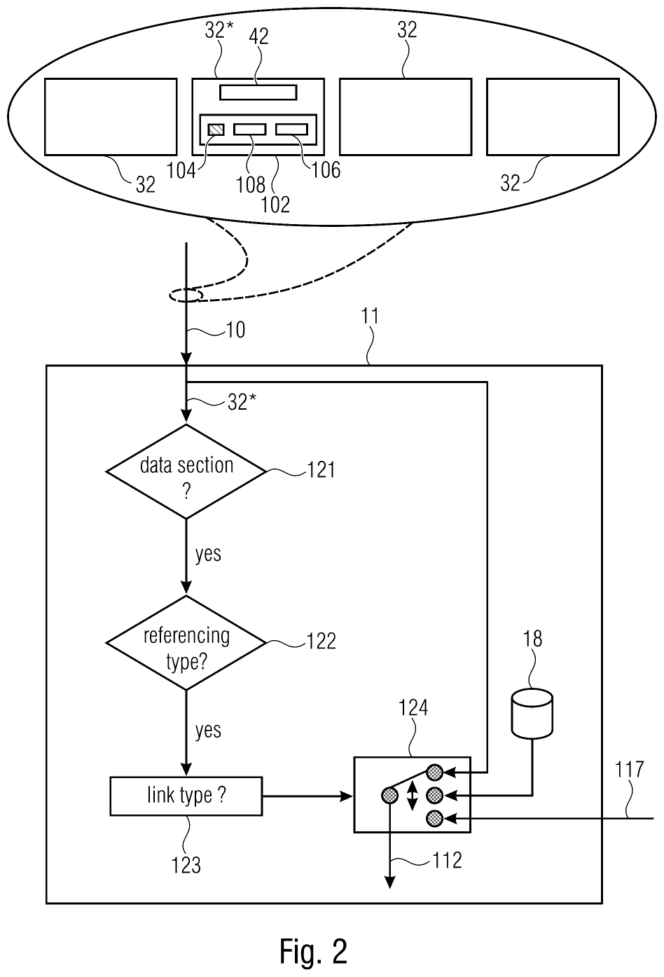

FIG. 2 illustrates an apparatus 11 for receiving a digital radio signal. Apparatus 11 may be a data application decoder, e.g. a broadcast receiver. Apparatus 11 of FIG. 2 may be referred to as receiver 11, and may optionally be an example of receiver 11 of FIG. 1. According to the embodiment of FIG. 2, the digital radio signal 10 carries text-based information content being divided into information objects 32, which are broadcasted in a data carousel manner, e.g., as described with respect to FIG. 1. According to this embodiment, receiver 11 is configured to receive an information object containing text information, referred to as predetermined information object 32* in FIG. 2. Receiver 11 parses the predetermined information object 32* with checking, in block 121 of FIG. 2, whether the predetermined information object comprises one or more data sections for supplementing the text information. In FIG. 2, the predetermined information object 32* is exemplarily illustrated as having a data section 102, the data section comprising a type indicator 104. For example, the type indicator indicates the type of data carried in the data section, e.g. by referencing one of a set of data types, e.g. as defined with respect to “DS type” in Table 4. For example, the set of data types comprises one or more of the data types defined in Table 4. If the predetermined information object comprises one or more data sections 102 for supplementing the text information, receiver 11 checks the type indicator 104 of a predetermined data section, e.g., the first data section of the one or more data sections, see block 122 of FIG. 2, to check if the type indicator indicates that the predetermined data section is of an image referencing type. As illustrated in FIG. 2, a data section 102 of the image referencing type comprises a link type indicator 108 and link information 104. For example, the link type indicator indicates, to which type out of a set of types the link information refers. If the predetermined data section 102 is of the image referencing type, receiver 11 reads the link type indicator 108 and the link information 106 from the predetermined data section 102, see block 123 of FIG. 2. For example, the link type indicator indicates the source to which a link indicated by the link information refers. In block 124 of FIG. 2, receiver 11 uses the link information 106 and the link type indicator 108 so as to access image data with accessing the image data from a local memory 18 comprised by the apparatus 11, if the link type indicator 108 assumes one or more first states (e.g., link type local of Table 6). Alternatively, if the link type indicator assumes one or more second states (e.g., link type URL of Table 6), receiver 11 accesses the image data from an external memory external to the apparatus 11 as indicated by input 117 in FIG. 2, e.g. via a communication network, e.g. via the internet. If the link type indicator assumes one or more third states (e.g., link type Embedded or Radio-URI), receiver 11 accesses the image data from the digital radio signal 10, e.g., from the predetermined data section 102 or from a channel for data transmission of the digital radio signal.

According to an embodiment, receiver 11 is configured for accessing the image data from the predetermined data section 102, if the link type indicator assumes one or more third states, e.g., as described with respect to link type “Embedded” of Table 6.

According to a further embodiment, the predetermined information object 32* is contained in a first channel of the digital radio signal, and the receiver 11 is configured for accessing the image data from a second channel of the digital radio signal, if the link type indicator assumes one or more third states, e.g., as described with respect to link type “Radio-URI” of Table 6.

According to an embodiment, wherein the predetermined information object is contained in a first channel of the digital radio signal, and wherein the apparatus is configured for accessing the image data from the predetermined data section, if the link type indicator assumes one or more first ones (e.g., “Embedded” of Table 6) of the one or more third states, and accessing the image data from a second channel of the digital radio signal, if the link type indicator assumes one or more second ones (e.g., “Radio-URI” of Table 6) of the one or more third states.

For example, the link type indicator is defined as described in Table 6 below.

According to an embodiment, a data section of the image reference type is defined as described below in section 5.3.2.4.

Images and graphics can make a Journaline service more attractive. Currently, there is no option to transfer images and graphics in Journaline or to signal how the receiver may obtain these images and graphics. Examples, how images may be used, are the usage of a reference to local image files—already present on the receiver—or image files on the internet (HTTP-URL). Storing images in the memory of the receiver beforehand is only practical in few cases of application. A dependency on internet access is in conflict with the idea of broadcasting. Embodiments of the invention allow a signaling of an image in the digital radio signal. Embodiments of the invention may be backwards compatible with legacy Journaline decoders, and may allow multiple types of access, from embedded to online reference (expandable). The image signaling can be ignored easily (e.g. for smart speakers without screen, or car receivers with text-to-speech output). Embodiments may provide an Option for accompanying description texts.

According to an embodiment, the predetermined information object 32* comprises a header section and a data section, the data section containing the text information. For example, the header section may comprise an object identifier 34.

A further embodiment of the invention is an apparatus for providing the digital radio signal described with respect to FIG. 2. For example, apparatus 20 illustrated in FIG. 1 may be implemented as described hereafter, wherein details described with respect to FIG. 1 are optional. According to an embodiment, apparatus 20 is for providing a digital radio signal carrying text-based information content being divided onto information objects, and apparatus 20 is configured to provide the information objects in a data carousel manner, the apparatus configured to provide a predetermined information object containing text information, wherein the predetermined information object comprises one or more data sections (e.g., a page) for supplementing the text information. According to this embodiment, the apparatus 20 is configured to provide the predetermined information object 32* containing text information by providing, in the predetermined information object 32*, one or more data sections 102 for supplementing the text information, and providing, in a predetermined data section (e.g., in the predetermined information object), a type indicator of the predetermined data section which indicates that the predetermined data section is of an image referencing type; and providing, in the predetermined data section, a link type indicator and link information, wherein the link information and the link type indicator indicate to access image data with accessing the image data from a local memory comprised by a receiver, if the link type indicator assumes one or more first states, accessing the image data from an external memory external to the receiver, if the link type indicator assumes one or more second states, and accessing the image data from the digital radio signal 10, e.g., from the predetermined data section 102 or from a channel for data transmission of the digital radio signal, if the link type indicator assumes one or more third states.

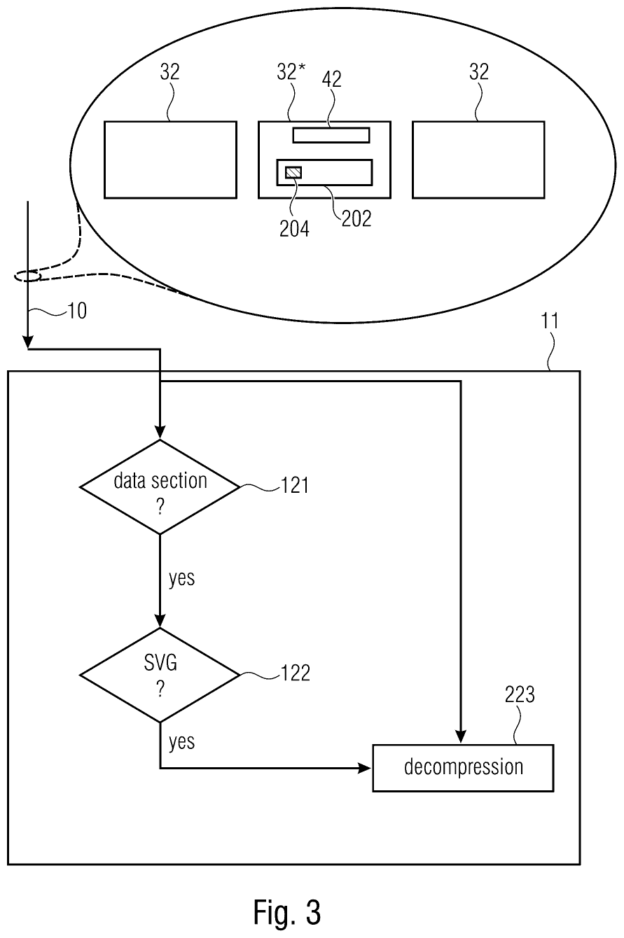

FIG. 3 illustrates a further embodiment of apparatus 11 for receiving a digital radio signal. Apparatus 11 may be a data application decoder, e.g. a broadcast receiver. Apparatus 11 of FIG. 3 may be referred to as receiver 11, and may optionally be an example of receiver 11 of FIG. 1. Furthermore, the features described with respect to FIG. 2 may optionally, but not necessarily be implemented in the embodiment of FIG. 3.

According to the embodiment of FIG. 3, the digital radio signal 10 carries text-based information content being divided into information objects 32, which are broadcasted in a data carousel manner, e.g., as described with respect to FIG. 1. According to this embodiment, receiver 11 is configured to receive one of the information objects 32 referred to as predetermined information object 32*. The predetermined information object 32* contains text information 42. Receiver 11 parses the predetermined information object 32* with checking, in block 221 of FIG. 3, whether the predetermined information object comprises one or more data sections (e.g., a (Journaline) page) for supplementing the text information 42. In the example of FIG. 3, the predetermined information object comprises one data section 202.

In examples, the one or more data sections 202 may be implemented as described with respect to data section 102 of FIG. 2.

According to the embodiment of FIG. 3, if the predetermined information object 32* comprises one or more data sections 202 for supplementing the text information 42, the receiver 11 checks, cf. block 222 of FIG. 3, one or more indicators 202 of a predetermined one of the data sections, e.g. a first one of the data sections, if the predetermined data section is for supplementing the texture information by an image represented by compressed SVG data. According to this embodiment, receiver 11 uses a predetermined decompression algorithm, see block 223 of FIG. 3, for decompressing the text information 42, and use the predetermined decompression algorithm, e.g., the same decompression algorithm, for decompressing the SVG data.

For example, the one or more indicators may correspond to indicators 104 and 108 of FIG. 2, and if the link type indicator 108 indicates that image data is to be retrieved from the digital radio signal 10, the receiver may infer that the digital radio signal comprises an image represented by compressed SVG data which is to be retrieved. For example, the SVG data may be contained in the link information field 106 described with respect to FIG. 2, e.g. as described in section 5.3.2.3 below, in particular, in Table 6.

For example, the SVG data is compressed as described in section 5.3.2.3 below.

E.g., Journaline page is limited to 4 kB and embedded SVG would be too big, because it needs to stay in 4 kB limit. According to an embodiment, the SVG data is compressed in advance with Journaline algorithm, e.g., by apparatus 20, and, optionally, the whole Journaline page (e.g., comprising the compressed SVG data, e.g. the information object 32) is compressed with same algorithm (e.g., a specially limited compression algorithm).

According to an embodiment, if the predetermined information object 32* comprises one or more data sections (e.g., a page) for supplementing the text information, receiver 11, decompresses the one or more data sections using the predetermined decompression algorithm, and if the predetermined data section is for supplementing the texture information by an image represented by compressed SVG data, receiver 11 decompresses the SVG data using the predetermined decompression algorithm.

According to an embodiment, receiver 11 may decompress the predetermined data structure using the predetermined decompression algorithm, and subsequently decompress the SVG data contained in the predetermined data structure.

A further embodiment is an apparatus for providing the digital radio signal 10 described with respect to FIG. 3. For example, apparatus 20 illustrated in FIG. 1 may be implemented as described hereafter, wherein details described with respect to FIG. 1 are optional. According to an embodiment, apparatus 20 is configured to provide the information objects in a data carousel manner, and to provide a predetermined information object containing text information, wherein the predetermined information object comprises one or more data sections 202 (e.g., a page) for supplementing the text information. According to this embodiment, apparatus is configured for providing the predetermined information object 32* by using a predetermined compression algorithm for compressing SVG data, e.g. an image, and embedding the SVG data into a predetermined one of the data sections, e.g. data section 202 of FIG. 3.

According to an embodiment, apparatus 20 uses the (e.g., the same) predetermined compression algorithm for compressing the text information (e.g., having embedded therein the compressed SVG data).

According to an embodiment, apparatus 20 uses the (e.g., the same) predetermined compression algorithm for compressing the predetermined data section 202 (e.g., having embedded therein the compressed SVG data).

SVG (Scalable Vector Graphic) is an XML based specification for describing vector graphics. SVG provides high compatibility, but also very large files compared to binary formats. Examples of the invention provide a method for compressing SVG files for embedding in Journaline pages (also works for externally linked/referenced files(!)—new file format/file extension .svgx defined), minimal additional effort for manufacturers on the decoder side, because compression, as the same decompressor is used that receivers with Journaline already contain, e.g., for decompressing text information or data sections.

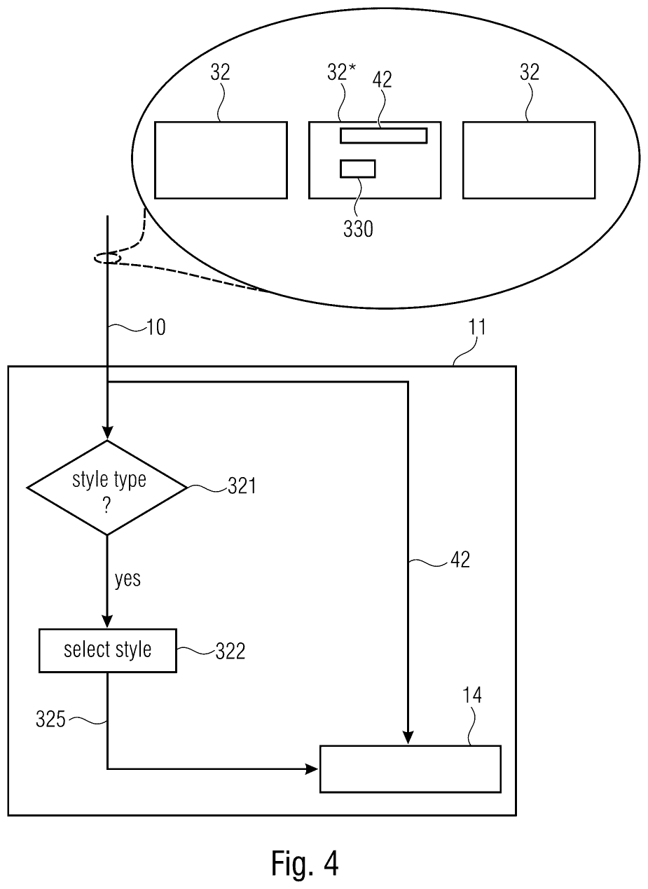

FIG. 4 illustrates a further embodiment of apparatus 11 for receiving a digital radio signal. Apparatus 11 may be a data application decoder, e.g. a broadcast receiver. Apparatus 11 of FIG. 4 may be referred to as receiver 11, and may optionally be an example of receiver 11 of FIG. 1. Furthermore, the features described with respect to FIG. 2 and/or FIG. 3 may optionally, but not necessarily be implemented in the embodiment of FIG. 4. According to the embodiment of FIG. 4, the digital radio signal 10 carries text-based information content being divided into information objects 32, which are broadcasted in a data carousel manner, e.g., as described with respect to FIG. 1. According to this embodiment, receiver 11 is configured for receiving an information object 32* of the information objects 32, e.g., referred to as predetermined information object. Information object 32* contains text information 42. According to this embodiment, the information object 32* may comprise one or more style indicators 330, e.g. as illustrated in FIG. 4. Receiver 11 parses the predetermined information object with checking whether the predetermined information object comprises one or more style type indicators 330, see block 321 of FIG. 4. If so, receiver 11 uses the one or more style type indicators 330 to select one or more or all predetermined presentation styles out of a plurality of different presentation styles of presenting the text information, see block 322 of FIG. 4. E.g., the style type indicator is associated with, or points to, the one or more or all predetermined presentation styles. Receiver 11 uses the one or more or all predetermined presentation styles to present the text information on a display 14 of the apparatus.

According to an embodiment, the predetermined presentation styles are associated with style information (e.g., the style information comprises images, e.g. background images, icons). According to this embodiment, the receiver 11 comprises a data storage, e.g. data storage 18 as illustrated in FIG. 1, having stored thereon the style information.

According to an embodiment, receiver 11 is configured to, if the predetermined information object comprises two or more style type indicators, select one out of the two or more style type indicators, and use the selected style type indicator to select the predetermined presentation styles.

For example, the one or more style type indicators 330 are implemented as described below in section 5.3.2.2. For example, the style type indicator 330 is signaled within or in form of a data section of the type “style reference”, see DS type “0xC1 Style Reference” of Table 4, which may be implemented as described in section 5.3.2.5.

For example, the information object may comprise, e.g. within a data structure of a style reference type, an indication indicating a type of a style reference. The types may include one or more of a first type, according to which the style reference refers to a local storage, on which the presentation style associated with the style reference is stored, a second type, according to which the style reference refers to a service component within the same or another DAB/DRM multiplex compared to the predetermined information object, which service component carries the presentation style associated with the style reference, a third type, according to which the style reference refers to a an internet address from which the presentation style associated with the style reference can be retrieved, and a fourth type, according to which the information object carries the presentation style, e.g., as described with respect to Table 7 below.

In examples, the types of style reference types may include, in addition to one or more of the first to fourth type, a fifth type, according to which the style reference indicates an style identifier, e.g., referencing a style-specific sub-folder, e.g. StyleID, as described in Table 7 below.

A further embodiment is an apparatus for providing the digital radio signal 10 described with respect to FIG. 4. For example, apparatus 20 illustrated in FIG. 1 may be implemented as described hereafter, wherein details described with respect to FIG. 1 are optional. According to an embodiment, apparatus 20 is configured to provide the information objects in a data carousel manner, and the apparatus is configured to provide a predetermined information object containing text information by providing, in the predetermined information object, one or more style type indicators 330, each being associated with one or more predetermined presentation styles out of a plurality of different (e.g., predetermined) presentation styles (e.g., being stored on a receiver).

Journaline supports the strict separation of content and representation. While for radio receivers, the representation of the text-based content depends mainly on the display used (or not →text-to-speech), it is desirable that Journaline pages, for example for public screens (public signage), can be designed individually; at the same time, however, compatibility with traditional Journaline decoders has to be maintained and the data overhead has to be minimized.

Examples of the invention are based on the idea to use one or more style references per Journaline page (incl. sub elements). Accordingly, the broadcaster can inform a correspondingly equipped Journaline decoder, via style references, which external style information (e.g., CSS (Cascading Style Sheets), JavaScript, background images, and icons) are to be used to represent the Journaline content of the page on the corresponding terminal device (e.g. public screen). Examples for such style references could be “Spiegel/NewsInternational” or “Sport1/Fußball/Bundesliga” or also generic ones not tied to a provider “Weather/Sunny” (e.g., for representing the appropriate icon).

The decoder side may profit from relying on established technology, e.g. CSS. In particular, embodiments of the invention provide a “referencing out of Journaline”/a linking between Journaline elements and CSS.

According to embodiments, the generated HTML pages (output of a corresponding Journaline decoder) are built according to standardized specifications (fixed CSS style references, HTML element structure, element IDs, etc.). Alternatively, the same concept can also be realized using style methods other than HTML/CSS, e.g., proprietary ones, depending on the terminal device/service provider.

Embodiments of the invention may provide the following advantages:
Backwards compatible signaling—Journaline core contents are still compatible with any existing Journaline decoder
Minimal Overhead per page
Offline filing of styling data locally in the terminal device, in a separate data service channel (e.g. Transparent File Transmission (TFT)), or referenced online
By reference to external style sets, these may be updated as required and also over long periods of time (low transmission volume) in the terminal devices in parallel with using the previous style set (for example as a further digital radio transmission TFT)—the update rate of the Journaline content is not affected by this at all
For each page, one or more pieces of styling data can be referenced. This allows for, for example, a styling specifically for a receiver class or even individual receivers by referencing local styling data (e.g. branding of a public screen provider or styling adjustments to the screen of the receiver) and a service-dependent styling (e.g. Weather/Sunny).
A receiver may set a base styling. This is applied without having to be referenced from the corresponding page. Styling references from the Journaline page may than expand on, refine, or even overwrite this base styling (or selected elements thereof).

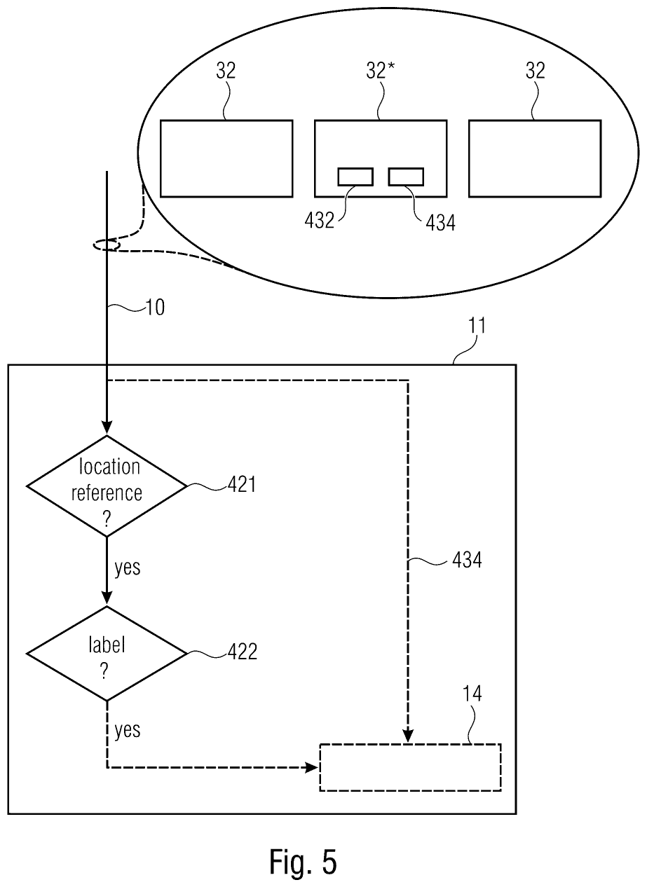

FIG. 5 illustrates a further embodiment of apparatus 11 for receiving a digital radio signal. Apparatus 11 may be a data application decoder, e.g. a broadcast receiver. Apparatus 11 of FIG. 5 may be referred to as receiver 11, and may optionally be an example of receiver 11 of FIG. 1. Furthermore, the features described with respect to any of FIG. 2 to FIG. 4 may optionally, but not necessarily be implemented in the embodiment of FIG. 5. According to the embodiment of FIG. 5, the digital radio signal 10 comprises an information service (e.g., a Journaline service) carrying information content (e.g., text-based information for presentation, visual information for presentation) being distributed onto information objects 32, which are broadcasted in a data carousel manner, e.g., as described with respect to FIG. 1. According to this embodiment, receiver 11 is configured for receiving an information object 32* of the information objects 32. Receiver 11 parses the information object 32* to check, whether the information object comprises one or more location references 432, each indicating a geographical location (e.g., a geographical position or a geographical region), see block 421 of FIG. 5. In the illustrative example of FIG. 5, the information object 32* comprises a location reference 432, and further comprises a label 434 for the location reference 432. Receiver 11 according to FIG. 5 is configured to, if the information object comprises one or more location references, check whether the information object comprises, for one or more of the location references 421, respective labels (e.g., which indicate semantics of the location references), see block 422 of FIG. 5.

Optionally, receiver 11 according to the embodiment of FIG. 5 may comprise a display 14, and receiver 11 may use the label 434 for presenting the location reference on the display.

In other words, according to an embodiment, receiver 11 is configured for providing the location references for presentation (e.g. via an output module 14, e.g., a display of a navigation system, which may be part of the apparatus or be connected with the apparatus) (e.g., for selection by a user, e.g., the apparatus comprises an input module for receiving input from a user), and receiver 11 is configured for, in providing the location references, using the labels (e.g. for the location references, for which the information object comprises respective labels. E.g., the location references, for which the information object comprises respective labels may be presented to the user using the labels, so that the label is presented to the user.)

According to an embodiment, receiver 11 may parse a content section of the information object, to check whether the content section comprises a first data section comprising one or more location references, and if the information object comprises one or more location references, check whether the content section comprises a second data section comprising the labels for the one or more of the location references.

According to an embodiment, the location references are signaled in a first data section of the information object, and wherein the labels are signaled in a second data section of the information object.

According to an embodiment, each of the geographical locations is associated with a respective content item.

For example, the one or more geographical locations are signaled as described with respect to the location reference types “latitude/longitude positions” or “latitude/longitude regions” in Table 4.

According to an embodiment, the labels are signaled as described with respect to “position/region labels” in Table 4.

According to an embodiment, the geographical location 432 is signaled within or in form of a data section comprised in the information object 32*, e.g. a data section of one of the types “latitude/longitude positions” or “latitude/longitude regions” described in Table 4. Additionally or alternatively, the label is signaled within or in form of a data section comprised in the information object 32*, e.g. a data section of the type “position/region labels” of Table 4.

A further embodiment is an apparatus for providing the digital radio signal 10 described with respect to FIG. 5. For example, apparatus 20 illustrated in FIG. 1 may be implemented as described hereafter, wherein details described with respect to FIG. 1 are optional. According to an embodiment, apparatus 20 is configured to provide the information objects in a data carousel manner, and the apparatus is configured to provide an information object 32* by providing, in the information object 32*, one or more location references 432, each indicating a geographical location (e.g., a geographical position or a geographical region), and for one or more of the location references, respective labels 434 (e.g., which indicate semantics of the location references).

According to an embodiment, apparatus 20 is configured to provide the location references in a first data section of the information object, and to provide the labels in a second data section of the information object.

In other words, embodiments of the invention allow to assign multiple (non-filtering) positional and regional markers to a Journaline page.

As an illustrative example: The Journaline page, e.g. text information contained in the information object, describes a concert, the positional references contain references to a concert entrance, nearest parking lot for cars, and nearest local public transport station (->traditional Journaline). While the pure signaling of positional references leaves the references semantically not distinguishable, embodiments according to the invention allow to signal a labelling of the positional references.

According to embodiments, the radio signal comprises separate escape sequence/data type for region/position label, thereby providing a backwards compatible addition with legacy Journaline decoders. In particular, according to examples, the coding of regions/locations may be unchanged (because separate, parallel DS type) with respect to previous Journaline versions.

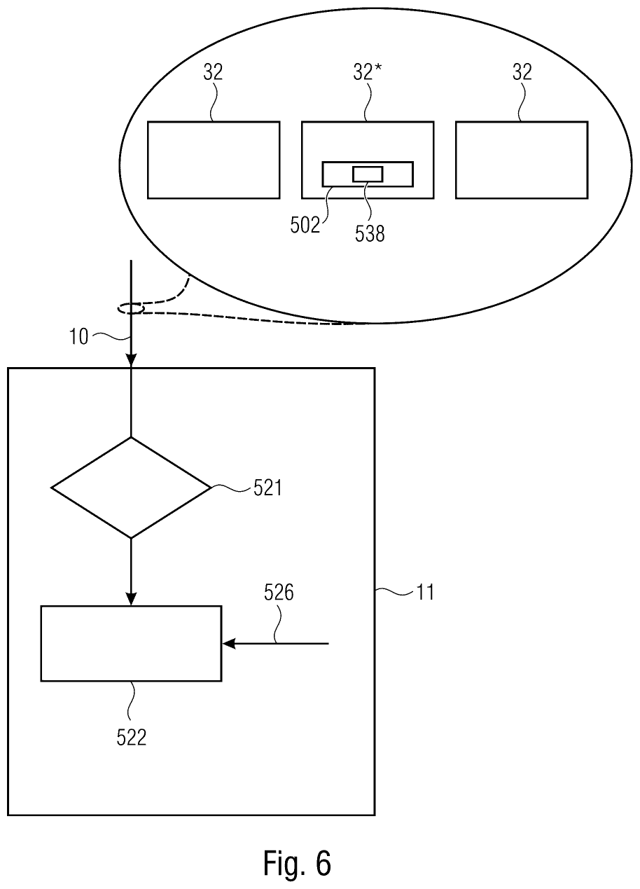

FIG. 6 illustrates a further embodiment of apparatus 11 for receiving a digital radio signal. Apparatus 11 may be a data application decoder, e.g. a broadcast receiver. Apparatus 11 of FIG. 6 may be referred to as receiver 11, and may optionally be an example of receiver 11 of FIG. 1. Furthermore, the features described with respect to any of FIG. 2 to FIG. 5 may optionally, but not necessarily be implemented in the embodiment of FIG. 6. According to the embodiment of FIG. 6, the digital radio signal 10 comprises an information service (e.g., a Journaline service) carrying information content (e.g., text-based information for presentation, visual information for presentation) being distributed onto information objects 32, which are broadcasted in a data carousel manner, e.g., as described with respect to FIG. 1. According to this embodiment, receiver 11 is configured for receiving a predetermined information object 32*. Receiver 11 may parse the predetermined information object to check, e.g. in block 521 of FIG. 6, whether the predetermined information object comprises a data section 502 comprising information 538 about a geographical region to which the predetermined information object is relevant, e.g., as it is illustrated in FIG. 6. If the predetermined information object comprises a data section comprising the information about the geographical region, receiver 11 may compare, block 522 of FIG. 6, the information about the geographical region with an information 526 about a geographic location of the receiver 11 to determine whether the predetermined information object 32* is relevant to the apparatus (or a user of the apparatus).

For example, receiver 11 may hold the information 526 about its geographical location in a data storage (e.g., derived from a use input), and/or may comprise means for determining the location.

For example, receiver 11 may consider the predetermined information object relevant, if the comparison between the geographical region signaled in the predetermined information object and the geographical location of the receiver match, i.e., e.g., that the location of the receiver is within a geographical region indicated by the information 538.

According to an embodiment, receiver 11 is configured to if the predetermined information object is not relevant to the apparatus, indicating the information object as being irrelevant and/or excluding the information object from presentation (e.g., skip a presentation of the predetermined information object in presenting a sequence of information objects).

According to an embodiment, each information object comprises an object identifier, e.g. identifier 34 described with respect to FIG. 1, and menu information objects (e.g. object 32″ of FIG. 1) comprise links 36 to reference referenced information objects by pointing to the object identifier of the referenced information objects. As described with respect to FIG. 1, receiver 11 may be configured to, based on starting from a start information object being identified by a start object identifier, navigate through information objects and present (e.g., to a user) information obtained from a currently selected information object (e.g., the selection of an information object is performed in response to a user input, or by an algorithm (e.g., presenting the information objects one after the other)). According to the embodiment of FIG. 6, receiver 11 may, if the predetermined information object is not relevant to the apparatus, indicating the information object as being irrelevant or exclude the information object from presentation in the presentation of a higher-ranked menu object having a reference to the predetermined information object. For example, receiver 11 does not indicate the information object as being irrelevant or exclude the information object from presentation in the presentation of a higher-ranked menu object if the comparison 522 yields that the predetermined information object is relevant.

According to an embodiment, the digital radio signal may carry an alarm announcement in a service signal or service channel of the digital radio signal. E.g., the alarm announcement may be signaled as being active or inactive, where an active alarm announcement may indicate, e.g., that an emergency situation is present and that further information on the alarm is transmitted in the digital radio signal, e.g., in one of the information objects 32.

According to an embodiment, receiver 11 may, in response to an active alarm announcement signaled in a service signal (or service channel) of the digital radio signal, the active alarm announcement being associated to the predetermined information object (e.g., the alarm announcement has, or is linked to, a reference to the predetermined information object), perform the parsing of the predetermined information object 32*, and if the predetermined information object is relevant to the receiver (based on comparison 522), refrain from initiating a presentation of the information object. According to an embodiment, e.g. as described with respect to FIG. 1, each of the information objects is signaled in the information service in a respective data structure comprising an identifier 34 of the respective information object 32.

According to an embodiment, the apparatus comprises a location module configured for determining the information about the geographical location of the apparatus (e.g., a GNSS receiver).

According to an embodiment, data section 502 carrying the information 526 on the geographical region may be implemented as described in section 5.3.2.2 below, e.g. as described with respect to the data section type “JML object filtering by latitude/longitude region” of Table 4.

According to an embodiment, receiver 11 may filter the information objects by relevance based on the information 538 as described in section 7.2.8.2 below.

In other words, embodiments described with respect to FIG. 6 may allows for the definition of a relevance range for each Journaline page.

For example, a location-aware receiver (e.g. GNSS such as GPS or Galileo) can decide based on the information, whether the page is relevant for the current position of the user.

For example, in the field of Emergency Warning Functionality, if the filter information is available on the landing page of the EWF Journaline service and the receiver determines that the user is currently outside the affected area, it can automatically switch back to the radio service previously listened to and ignore this specific alarm message (e.g., until the user possibly moves into said relevance range)

Embodiments may be fully downwards compatible implementation with legacy Journaline decoders.

Embodiments may use the same position format for the definition of a region as the non-filtering traditional definition of a region for a Journaline page (DS type 0xB1), thereby minimizing the decoder effort.

A further embodiment is an apparatus for providing the digital radio signal 10 described with respect to FIG. 6. For example, apparatus 20 illustrated in FIG. 1 may be implemented as described hereafter, wherein details described with respect to FIG. 1 are optional. According to an embodiment, apparatus 20 is for providing a digital radio signal, the digital radio signal comprising an information service (e.g., a Journaline service) carrying information content (e.g., text-based information for presentation, visual information for presentation) being distributed onto information objects, the apparatus configured for providing the information objects in a data carousel manner, wherein the apparatus is configured to provide an information object by providing, in the information object, a data section 502 comprising information 538 about a geographical region to which indicates the predetermined information object is relevant.

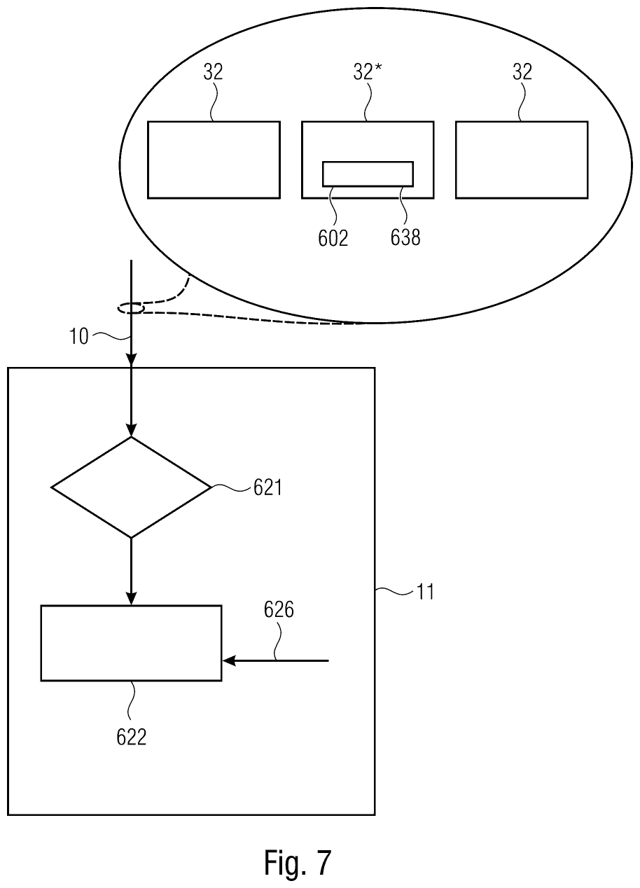

FIG. 7 illustrates a further embodiment of apparatus 11 for receiving a digital radio signal. Apparatus 11 may be a data application decoder, e.g. a broadcast receiver. Apparatus 11 of FIG. 7 may be referred to as receiver 11, and may optionally be an example of receiver 11 of FIG. 1. Furthermore, the features described with respect to any of FIG. 2 to FIG. 6 may optionally, but not necessarily be implemented in the embodiment of FIG. 7. According to the embodiment of FIG. 7, the digital radio signal 10 comprises an information service (e.g., a Journaline service) carrying information content (e.g., text-based information for presentation, visual information for presentation) being distributed onto information objects 32, which are broadcasted in a data carousel manner, e.g., as described with respect to FIG. 1. According to this embodiment, receiver 11 is configured for receiving a predetermined information object 32*. Receiver 11 may parse the predetermined information object to check, e.g. block 621 of FIG. 7, whether the predetermined information object comprises a data section 602 comprising a target group information 638 which indicates a target group of the predetermined information object, e.g., as illustrated in FIG. 7. If the predetermined information object comprises a data section 602 comprising a target group information 638 for the predetermined information object, receiver 11 compares, block 622 of FIG. 7, the target group information with an information 626 about the apparatus to determine whether the apparatus belongs to the target group of the predetermined information object. E.g., receiver 11 may derive the target group information from the information service.

For example, the information 626 about the receiver may be stored in a data storage of receiver 11. Information 626 may be provided by a user input or may be determined by means of the receiver 11.

For example, the information 626 may be geographic location of receiver 11, so that features described with respect to FIG. 6 may equivalently apply to the embodiments described with respect to FIG. 7.

According to an embodiment, if comparison 622 yields that he apparatus does not belong to the target group of the predetermined information object, receiver 11 indicates the information object as being irrelevant and/or excludes the information object from presentation (e.g., skip a presentation of the predetermined information object in presenting a sequence of information objects).

According to an embodiment, each information object comprises an object identifier, and menu information objects comprise links to reference referenced information objects by pointing to the object identifier of the referenced information objects and the apparatus is configured to, based on starting from a start information object being identified by a start object identifier, navigate through information objects and present (e.g., to a user) information obtained from a currently selected information object (e.g., the selection of an information object is performed in response to a user input, or by an algorithm (e.g., presenting the information objects one after the other)), e.g. as described with respect to FIG. 1. According to the embodiment of FIG. 7, if the receiver 11 does not belong to the target group of the predetermined information object, receiver 11 indicates the information object 32* as being irrelevant or excludes the information object 32* from presentation in the presentation of a higher-ranked menu object having a reference to the predetermined information object (e.g., and do not indicating the information object as being irrelevant or exclude the information object from presentation in the presentation of a higher-ranked menu object of the apparatus belongs to the target group or if the information object does not include the target group information).

According to an embodiment, receiver 11 is configured to, in response to an active alarm announcement signaled in a service signal (or service channel) of the digital radio signal, the active alarm announcement being associated to the predetermined information object (e.g., the alarm announcement has, or is linked to, a reference to the predetermined information object), perform the parsing of the predetermined information object, and if the apparatus does not belong to the target group of the predetermined information object, refrain from initiating a presentation of the information object.

According to an embodiment, each of the information objects 32 is signaled in the information service in a respective data structure comprising an identifier 34 of the respective information object.

According to an embodiment, the target group information is indicative of a geographical region, and wherein the information about the apparatus comprises information about the geographical location of the apparatus.

According to an embodiment, the receiver 11 comprises the location module configured for determining the information about the geographical location of the apparatus (e.g., a GNSS receiver).

According to an embodiment, the target group information 638 comprises a plurality of geographical positions defining the geographical region. E.g., receiver 11 interprets the geographical positions as vertices of a polygon to derive the geographical position.

According to an embodiment, the target group information 638 is indicative of one or more tags (e.g., codes, e.g., strings, e.g., tagging strings), and wherein the apparatus is configured for checking, whether the information about the receiver comprises a tag which matches with one of the tags of the target group information (e.g., is identical, or is identical except for one or more wildcard characters at one or more positions of the tag of the target group information or the tag of the information about the apparatus) to determine whether the apparatus belongs to the target group of the information object.

For example, the code or string represents a ZIP code.

According to an embodiment, data section 602 carrying the information 626 on the geographical region may be implemented as described in section 5.3.2.2 below, e.g. as described with respect to the data section type “JML object filtering by latitude/longitude region” of Table 4.

According to an embodiment, receiver 11 may filter the information objects by relevance based on the information 638 as described in section 7.2.8.2 below.

In other words, embodiments according to FIG. 7 may be implemented according to the same or similar principle as those described with respect to FIG. 6, but the embodiments according to FIG. 7 may optionally rely on different information than a geographical location. Embodiments may be realizable for simple receivers without GPS receiver. For example, a Journaline page is marked as relevant for a particular zip code area x, y and z. If a tagging string stored in the Journaline object (incl. wildcard evaluation!) corresponds to least one string stored in the receiver, the page is relevant for the user, otherwise it is not.

For example, receiver 11 may be part of, or provide information for a public signage board being provided with current information via Journaline (e.g. via digital radio). In each board, an individual location code is stored, which can be addressed via the Journaline signaling.

Thus, the public screen only represents that information which is intended for it without a GPS receiver being required.

Embodiments may be fully downwards compatible implementation with legacy Journaline decoders.

A further embodiment is an apparatus for providing the digital radio signal 10 described with respect to FIG. 7. For example, apparatus 20 illustrated in FIG. 1 may be implemented as described hereafter, wherein details described with respect to FIG. 1 are optional. According to an embodiment, an apparatus for providing a digital radio signal, the digital radio signal comprising an information service (e.g., a Journaline service) carrying information content (e.g., text-based information for presentation, visual information for presentation) being distributed onto information objects, the apparatus configured for providing the information objects in a data carousel manner, wherein the apparatus is configured to provide an information object by providing, in the information object 32*, a data section 602 comprising a target group information 626 which indicates a target group of the predetermined information object.

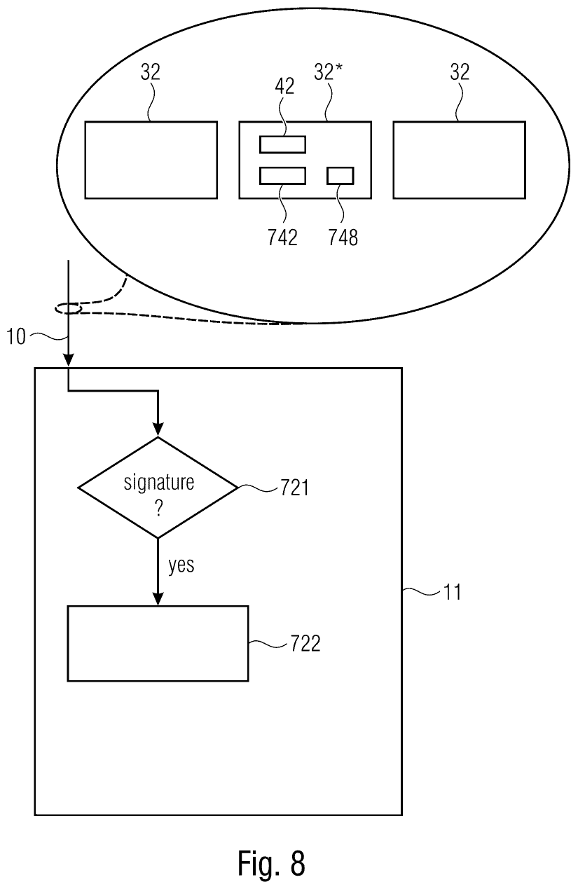

FIG. 8 illustrates a further embodiment of apparatus 11 for receiving a digital radio signal. Apparatus 11 may be a data application decoder, e.g. a broadcast receiver. Apparatus 11 of FIG. 8 may be referred to as receiver 11, and may optionally be an example of receiver 11 of FIG. 1. Furthermore, the features described with respect to any of FIG. 2 to FIG. 7 may optionally, but not necessarily be implemented in the embodiment of FIG. 8. According to the embodiment of FIG. 8, the digital radio signal 10 comprises an information service (e.g., a Journaline service) carrying information content (e.g., text-based information for presentation, visual information for presentation) being distributed onto information objects 32, which are broadcasted in a data carousel manner, e.g., as described with respect to FIG. 1. According to this embodiment, receiver 11 carries text-based information content being divided onto information objects 32, which are broadcasted in a data carousel manner. Receiver 11 according to FIG. 8 is configured for receiving a predetermined one of the information objects, referred to as information object 32* in FIG. 8. Information object 32* contains text information 42. Receiver 11 according to the embodiment of FIG. 8 parses the predetermined information object 32* with checking, see block 721 of FIG. 8. whether the predetermined information object comprises one or more signature data 742, as it is the case in the illustrative example of FIG. 8. If the predetermined information object comprises one or more signature data, receiver 11 checks, see block 722 of FIG. 8, whether a predetermined section 748 of the predetermined information object fits to a predetermined signature data of the one or more signature data in order to verify an integrity and/or an authenticity of the predetermined information object.

According to an embodiment, receiver 11 is configured to check, for each signature data, whether the predetermined section of the predetermined information object fits to the respective signature data and confirm the integrity and the authenticity of the predetermined information object if the predetermined section of the predetermined information object fits to the respective signature data.

According to an embodiment, each of the one or more signature data comprises a signature issuer ID and a signature value. For example, the signature issuer ID indicates an issuer of the signature data, the issuer having associated therewith an issuer-specific method for determining the signature value.

For example, the receiver 11 may be configured for calculating a reference signature value based on the predetermined section 748 of the predetermined information object 32*. Receiver 11 may check if the calculated reference signature value matches the signature value of the signature data 742, and if so, confirm integrity and/or authenticity of the predetermined information object.

For example, receiver may use the issuer-specific method for calculating the reference signature value.

For example, calculating the reference signature value may comprise encrypting data obtained based on the predetermined section using a method and/or a key, which is associated with the issuer ID and which is known to the receiver 11.

In more general words, according to an embodiment, receiver 11 is configured to, for each signature data, derive from the respective signature data, a signature issuer ID and a signature value, where the signature ID allows the apparatus to identify and verify if the signature data is supported and relevant, while the associated signature value allows to verify the integrity and authenticity of the predetermined section of the predetermined information object (e.g., the signature value could for example be created by applying a cryptographic key stored internally along with the supported issuer ID).

According to an embodiment, receiver 11 is configured to, for each signature data, derive from the respective signature data, a signature issuer ID and a signature value, wherein the apparatus is configured to use the signature issuer ID to identify a method for verifying the integrity and/or the authenticity of the predetermined section of the predetermined information object. Receiver 11 may verify the integrity and authenticity of the predetermined section of the predetermined information object using the identified method and the signature value (e.g.; the signature value could for example be created by applying a cryptographic key stored internally along with the supported issuer ID).

According to an embodiment, receiver 11 is configured to, for at least one of the one or more signature data, derive from the at least one signature data, a location of the predetermined section within the predetermined information object.

According to an embodiment, receiver 11 is configured to, for each of the one or more signature data, derive from the at least one signature data, a location of the predetermined section within the predetermined information object so that the location may vary among the one or more signature data.

Alternatively, the location of the predetermined section may be known to the receiver. The predetermined section may, for example, be associated with the signature issuer ID.

According to an embodiment, the signature data may be contained in a data section of the predetermined information object 32*, e.g., a specific data section for signaling signature data.

According to an embodiment, the signature data is contained in a data section of the type “content signature” as described in section 5.3.2.2 below, in particular in Table 4.

According to an embodiment, receiver 11, a corresponding encoder 20 (apparatus 20 for providing a digital radio signal) and the digital radio signal are implemented as described in section 7.2.8.3 below.

A further embodiment is an apparatus for providing the digital radio signal 10 described with respect to FIG. 8. For example, apparatus 20 illustrated in FIG. 1 may be implemented as described hereafter, wherein details described with respect to FIG. 1 are optional. According to an embodiment, an apparatus 20 for providing a digital radio signal carrying text-based information content being divided into information objects, is configured to provide the information objects in a data carousel manner, the apparatus configured to provide a predetermined information object containing text information by creating signature data for a predetermined section of the predetermined information object, and providing the signature data in the predetermined information object.

According to an embodiment, apparatus 20 is configured to create the signature data based on the predetermined section of the predetermined information using a predetermined method, and provide an signature issuer ID identifying the predetermined method in the signature data.

In other words, embodiments may allow for electronically signing a Journaline page. Embodiments may allow for verifying, by means of the decoder (e.g. reveiver), that the content of the page is a) unchanged (integrity) and/or b) originates from an authorized sender (authenticity). Such a feature may be particularly important e.g. for public screens or in the case of EWF information or otherwise critical information, which may have to be processed further or authenticated, for example by authorities, or which are generally subject to special safety requirements.

The method (signature mechanism, i.e. AES-based, for example) is not necessarily prescribed in Journaline, but rather is left to the respective service provider. This relates to the signature mechanism as well as the signature format and the content area to which the signature is meant to relate specifically (with/without Journaline header, etc.).

Embodiments disclosed herein provide the advantage of being able to capture the entire useful content of the Journaline object (if e.g. the signature tag is built in all the way at the end), and simultaneously to maximum flexibility with regards to requirements and future advancements in the field of signature algorithms being provided for the service providers. The signature and the mechanism used (i.e. the service provider and the version/type of signature) may be identified via signature ID, thereby providing maximum flexibility. In particular, embodiments allow for multiple parallel signatures by one provider (e.g. current and previous signature versions for legacy receivers) as well as the completely independent operation of providers that are independent from one another each having their own signature mechanisms.

For example, the receiver 11 may issue a warning and/or ignore the object if it (a) does not know the signer, (b) does not support the signature mechanism, or (c) determines a faulty signature.

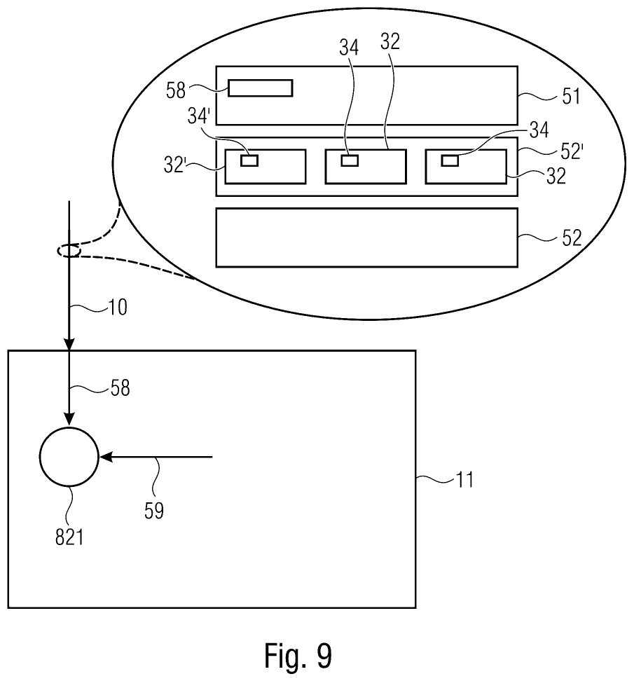

FIG. 9 illustrates a further embodiment of apparatus 11 for receiving a digital radio signal. Apparatus 11 may be a data application decoder, e.g. a broadcast receiver. Apparatus 11 of FIG. 9 may be referred to as receiver 11, and may optionally be an example of receiver 11 of FIG. 1. Furthermore, the features described with respect to any of FIG. 2 to FIG. 8 may optionally, but not necessarily be implemented in the embodiment of FIG. 9. According to the embodiment of FIG. 9, the digital radio signal 10 comprises a service signal 51 (e.g. a service channel) comprising information about a plurality of services signaled in the digital radio signal. In FIG. 9, two services 52, 52′ are illustrated as being signaled in the digital radio signal. Further, the digital radio signal 10 comprises an information service (e.g., a Journaline service) carrying information content (e.g., text-based information for presentation, visual information for presentation) being distributed onto information objects 32, which are broadcasted in a data carousel manner. The information service may be an individual service or may be part of one of the plurality of services. In FIG. 9, the information service is indicated using reference sign 52′. Each information object 32 comprises an object identifier 34, and menu information objects comprise links to reference referenced information objects by pointing to the object identifier of the referenced information objects, e.g., as described with respect to FIG. 1. According to this embodiment, the receiver 11 is configured to, based on starting from a start information object 32′ being identified by a start object identifier 34′, navigate through information objects and present (e.g., to a user) information obtained from a currently selected information object. E.g., in FIG. 9 the first of the illustrated information objects is the start information object 32′ of the information service 52′. According to the embodiment of FIG. 9, receiver 11 is configured to derive, from the service signal 51, a set 58 of one or more start object identifiers (for respective start information objects, e.g., each of the start information objects is associated with a respective service of the plurality of services). According to the embodiment of FIG. 9, receiver 11 checks, e.g. in operation 821 of FIG. 9, whether one of the set 58 of start object identifiers corresponds to a predetermined object identifier 59 (e.g., having a predetermined value). For example, the predetermined object identifier may be known to receiver 11. For example, the predetermined object identifier 59 may have a fixed, predetermined value.

For example, the start object identifiers indicated in set 58 may indicate, for each service 52, 52′, which of the information objects of the respective service is the start information object by identifying one of the object identifiers as being the start object identifier, i.e., the object identifier of the start information object.

According to an embodiment, receiver 11 is configured to, if one of the set 58 of start object identifiers corresponds to the predetermined object identifier, present (e.g., to a user) an indication indicating a presence of the information object having the predetermined object identifier (e.g., a presence in the information service).

According to an embodiment, the predetermined object identifier is associated with an information object related to an emergency warning and emergency-related information.

A further embodiment is an apparatus for providing the digital radio signal 10 described with respect to FIG. 7. For example, apparatus 20 illustrated in FIG. 1 may be implemented as described hereafter, wherein details described with respect to FIG. 1 are optional. According to an embodiment, an apparatus 20 for providing a digital radio signal 10 (e.g., Broadcast receiver), the digital radio signal comprising a service signal 51 comprising information about a plurality of services 52, 52′ signaled in the digital radio signal 10, wherein the digital radio signal comprises an information service 52′ (e.g., a Journaline service) carrying information content (e.g., text-based information for presentation, visual information for presentation) being distributed onto information objects 32, which are broadcasted in a data carousel manner. Each information object comprises an object identifier 34, and menu information objects comprise links to reference referenced information objects by pointing to the object identifier of the referenced information objects. The apparatus is configured to provide, in the service signal 51, a set 58 of one or more start object identifiers (for respective start information objects, e.g., each of the start information objects is associated with a respective service of the plurality of services), wherein one of the set of start object identifiers corresponds to a predetermined object identifier (e.g., having a predetermined value, e.g., being associated with an information object having emergency information).

According to an embodiment, receiver 11, a corresponding encoder 20 (apparatus 20 for providing a digital radio signal) and the digital radio signal 10 are implemented as described in section 7.2.8.1 below.

In other words, embodiments may implement the principle that due to the presence of a strictly defined Journaline object ID (here e.g. 0xffff), e.g., the predetermined object identifier 34′, in the service, a) specific states can be described implicitly (e.g. presence of EWF information), and b) special landing pages can be defined for special applications without affecting the “regular” service landing pages in the Journaline page for existing providers. The special ID 0xffff serves as an example and a different set ID may also be used.

Furthermore, the principle can also be applied to applications other than the EWF use case.

In other words, examples of the invention provide a principle that by linking the mechanisms of “special landing page in Journaline” and “signaling an alternative landing page”, information on particular relevant information, even such information going beyond Journaline, can be provided in a manner that is very timely for the receiver and also at a high signaling level (e.g. already in the service list representation) (as in the specific example of EWF: This is not an “Emergency Programme”—clearly discernible for the receiver even when there is no active alarm signal (any more) referring to this program). An example of this aspect of the invention is described in chapter 7.2.8.1. Chapter 7.2.8.1 describes an example, of the desired receiver behavior and the related encoder specifications for the special use case of “EWF Emergency Warning Functionality” as an embodiment.

In the following, embodiments of the invention are described, which are implemented based on Journaline, in particular based on ETSI TS 102 979 v1.1.1 (2008-06), which is available at: https://www.etsi.org/deliver/etsi_ts/102900_102999/102979/01.01.01_60/ts_102979v0101 01p.pdf.

The following section describe embodiments of the invention by indicating additions and modification to ETSI TS 102 979 v1.1.1. Any features of ETSI TS 102 979 v1.1.1 may optionally be implemented in embodiments of the invention. In the following amended version of ETSI TS 102 979 v1.1.1, Chapters without relevant changes compared to this published standard have been removed from this version of the document for clarity. However, section and table numeration is maintained for comparison to ETSI TS 102 979 v1.1.1. However, those chapters from the base document may contain useful background information for the better understanding of the modifications described in this document. The amended version of ETSI TS 102 979 v1.1.1 presented below may be referred to as ETSI TS 102 979 v1.2.1, e.g., as Draft 15.

In other words, according to an embodiment, receiver 11, apparatus 20 and digital radio signal 10 may be conformant to ETSI TS 102 979 v1.1.1. According to an embodiment, receiver 11, apparatus 20 and digital radio signal 10 may be conformant to ETSI TS 102 979 v1.1.1 as amended according to the claims, or as amended as indicated below. It is noted that the additions and modifications described below may be implemented individually from each other. This is particularly true for the individual aspects referred to above with respect to FIGS. 2 to 9.

The below specification may be employed for Digital Audio Broadcasting (DAB); Digital Radio Mondiale (DRM); Journaline.

### 3 Definitions, Abbreviations and Conventions

### 3.1 Definitions

For the purposes of the present document, the following terms and definitions apply:
broadcaster/encoder: instance that encodes and provides a Journaline service
content section: part of a JML object after the header section that carries the useful content
DS payload: block of data contained in escape sequences of type “Data section Start” and “Data section Continuation”
header section: part of a JML object preceding the content section and carrying descriptive information on the JML object
hierarchy level: number of object IDs traversed on the shortest navigation path from the root object to the current JML object
history path: list of object IDs the user has traversed from the root object to the current JML object
hot button: function (e.g. a key that can be pressed) that allows a user to initiate a form of interaction linked to a JML object
Journaline Markup Language (JML): XML based binary encoding scheme used for the transmission of JML objects
Journaline object: one data unit to be transmitted, carrying for example one JML object or one block of Management data
JML object: encoded representation of an object
main menu: root object if it is of type “menu”
menu object: JML object of type “menu”
message object: JML object of type “plain-text message”, “title-only message” or “list message”
object: information unit (i.e. one message or “page” of the Journaline service) that can be rendered on screen, like a menu, a plain-text message, etc
object ID: unique identifier of a JML object within the Journaline service point of entry: object that shall initially be presented to the user if no other point of entry is defined by other means; usually the root object
receiver: instance that decodes a Journaline service and presents it to the user
root object: JML object with object ID “0x0000”, serving as the default point of entry to the Journaline service
static flag: signalling to the receiver that a JML object with a specific object ID will in future carry the same type of content. Therefore the user might choose to store the object ID as a favourite (bookmark) for quick access
TOC block: one block of management data carrying, among other information, a list of TOC entities, which represent all JML objects currently broadcast as part of the Journaline service
TOC fragment: if the complete list TOC entities cannot be carried in a single TOC block, the information is split up into multiple TOC blocks referred to as TOC fragments
TOC entity: description of a single JML object within a TOC block

### 3.2 Abbreviations

For the purposes of the present document, the following abbreviations apply:
CRC Cyclic Redundancy Check
DAB Digital Audio Broadcasting
DRM Digital Radio Mondiale
ID Identifier
IPA International Phonetic Alphabet
JML Journaline Markup Language
LSB Least Significant Bit
MOT Multimedia Object Transfer
MSb Most Significant bit
MSB Most Significant Byte
MSC Main Service Channel
PAD Programme Associated Data
RSS Real Simple Syndication
NOTE: (XML based news distribution format on the Internet).
TOC Table Of Contents
UTF-8 8-bit UCS/Unicode Transformation Format
XML eXtensible Markup Language

### 4 Overview

Journaline is a text based information service for digital radio, optimized for simple data aggregation and re-use at the broadcast encoder side, as well as highly efficient broadcast transmission. Due to low decoder resource requirements, it supports the widest range of receiver types, from low-cost solutions with a small text display up to high-end receivers with graphical user interfaces and optional text-to-speech playback.

The radio user can instantly and interactively access all information provided by the radio station, comparable to teletext for TV. The core information is provided in simple textual form with the option for richer graphical representation including a future extension to multimedia elements like video or audio sequences. The flexible coding of Journaline allows for future extensions as well as the provision of additional non-textual information in a fully backward compatible way.

The information is hierarchically organized based on menus. Every menu contains a list of sub-menus and/or messages. Messages carry one piece of information each (e.g. a list of football scores, a news item, a cooking recipe, background information for a traffic message, etc.).

Messages and (sub-)menus each represent one “page” of the Journaline service, and will jointly be referred to as “objects” (“menu objects” and “message objects”) in the remaining document.

Journaline is based on common public standards:
Objects can be generated and fed into a Journaline enabled transmission system as XML files.
Journaline capable receivers can easily restore an XML representation of each object for further processing, or directly parse the transmitted binary representation for increased efficiency.

Journaline is highly optimized for use in digital broadcast systems and provides:
Added value for listeners. Immediate access to textual information everywhere.
Ease of use. Simple navigation through a minimum user interface consisting of a text screen plus up/down, select and back keys.
Great benefit for all types of receivers. From low-cost receivers with small text display to high-end receivers with graphical user interface and optional speech playback.
Increased listener loyalty for broadcasters. Minimum additional bit rate for extended listener support.
Automatic re-use of existing information sources and feeds. Many text-based information sources like RSS feeds can be broadcast with minimum transformation effort.

The following technical principles ensure the stated functional highlights:
All aspects of the Journaline specification are tailored towards low-footprint implementations even in low-complexity receivers as well as ease of use.
To reduce the decoder footprint on low-complexity receivers, an object's main visual content is formatted as pure textual information.
Every object is self-describing and self-contained. No global data structures need to be assembled or maintained in the receiver, and no external information is required to present a Journaline object to the user.
Objects are usually broadcast in form of a data carousel. Data caching in the receiver is supported but not mandatory.
Object transmission repetition can depend on individual access time requirements (priority class concept) to optimize availability of information on initial startup. For example, menu objects may be broadcast more frequently than message objects.
Objects can be updated at any time without affecting other components of the Journaline service, and real-time information like ticker messages can be inserted at any time interrupting running data carousels.
To prevent unnecessary data overhead (and thereby minimize transmission time), objects are re-formatted for transmission into JML—the XML structured binary encoding “Journaline Markup Language”.
The provided receiver behaviour guidelines are a recommendation that should be fulfilled by any receiver according to its abilities and technical infrastructure. However, Journaline has a very carefully selected set of required mandatory receiver functionality that encapsulates the core use to the user and that can easily be implemented by the simplest receiver.
Receiver implementations can easily distinguish themselves by providing for example a richer graphical representation, Favourites functionality, or additional navigation support (like next and previous keys to speed up navigation through messages within the same menu).
All aspects of the Journaline specification can easily be extended in a fully backward compatible way to support new types of information or extended functionality.

### 4.1 JML Objects

Each piece of information (i.e. every menu, news article, ticker message, etc.) is transmitted to the receiver as a self-contained and self-describing “JML object”, i.e. no external information such as an object directory is required to present the content of this JML object to the user. To minimize the decoder footprint in the receiver, the receiver does not need to build or store any overall hierarchy or index information to render a JML object on screen and to provide the user with the defined methods of interaction (like menu selections).

JML (“Journaline Markup Language”), an XML based binary coded content representation, structures a JML object's content into blocks of information like title, body text, menu items, etc.

### 4.2 Types of JML Objects

Journaline currently specifies 4 types of JML objects:
Menus.
Plain text messages.
Title-only messages.
List messages.

These JML object types differ in their preferred way of presentation to the user as well as their behaviour in the case of a content update being received while the JML object is displayed on screen.

The JML object types also support individual types of JML information blocks. For example, a menu consists of one title block and a range of menu items, while a title-only message only carries a title block.

Unless explicitly stated otherwise, escape sequences (see clause 5.3.2 Escape Sequences) are allowed as part of all JML information blocks.

Encoded JML objects of type menu will be referred to as “menu objects”, while the different types of messages will be referred to as “message objects”.

### 4.2.1 Menu Object

A JML object of type menu (“menu object”) consists of a title block followed by a list of link items. Link items consist of a visible text label plus a reference to another JML object.

### 4.2.2 Message Objects

### 4.2.2.1 Plain Text Message

Plain text messages consist of a title block followed by a block of body text. This type of JML object is intended for the presentation of longer messages and articles.

### 4.2.2.2 Title-Only Message

Title-Only messages consist of one title block. The intended functionality is for example that of an automatically updated news ticker.

### 4.2.2.3 List Message

List messages consist of a title block and a list of content lines. Their purpose is to present information in list form (like sports results, stock market information, etc.) in an ordered fashion.

### 4.3 JML Object Hierarchy

The logical structure of a Journaline service is presented to the user as a tree of menus, sub-menus and messages.

All JML objects that form a Journaline service can be distinguished by their unique object ID. A Journaline service must at least comprise one JML object with the object ID value 0x0000, the “root object”.

### 5 JML Object—Format Specification

### 5.1 Overview

Every JML object is self-descriptive. No external information (like filename or type specification) is required to reference and access a JML object and to present it to the user.

A JML object consists of the “header section” followed by the “content section”.

The size of a JML object is limited to 4 092 bytes. This size comprises the object header and the uncompressed content section.

The content section may be compressed to improve transmission efficiency. However, a JML object shall not be compressed if the total size of the compressed version of the JML object exceeds the size of the uncompressed version.

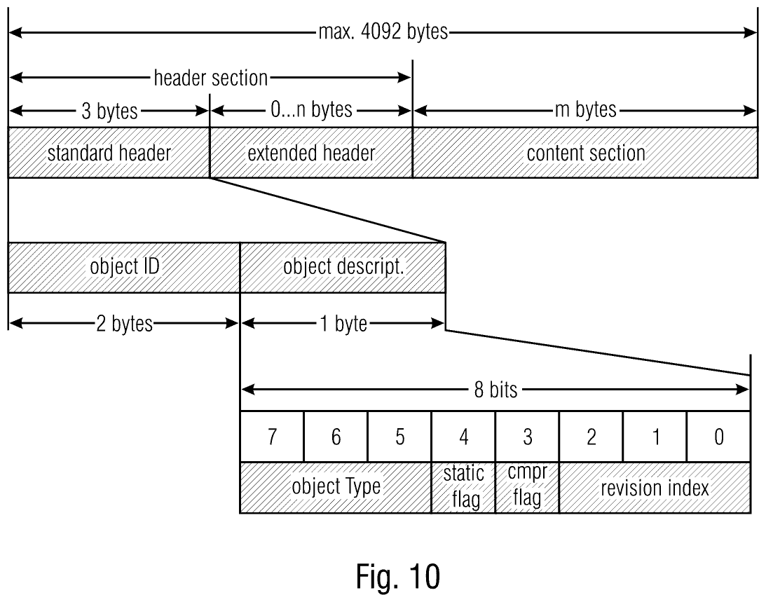

FIG. 10 illustrates components of a JML object according to an embodiment. For example, information objects 32 described with respect to FIGS. 1 to 9 may be implemented as shown in FIG. 10. For example, the object identifier 32 may correspond to the field object ID.

### 5.2 Header Section

The header section of a JML object consists of a mandatory “standard header” and an optional “extended header”.

The standard header comprises the object ID and the object description.

The presence and length of an extended header is indicated as part of the service signalling (see clause 8.1.2). If present, it has an equal size for all JML objects of the Journaline service. A receiver shall discard the extended header if it does not know how to interpret the content.

The standard header contains the following parameters:
Object ID 16 bits.
Object description: 8 bits.

Where the object description consists of:
Object Type 3 bits.
Static flag 1 bit.
Compress flag 1 bit.
Revision index 3 bits.

The following definitions apply:
Object ID: this 16-bit value uniquely identifies a JML object within a Journaline service:
   0x0000: assigned to the JML object serving as the default point of entry; the only object ID that must always be present in a Journaline service.
   0x0001 to 0xEFFF: freely assigned to JML objects by the broadcaster/encoder.
   0xF000 to 0xFFFE: reserved for future definition of specific content types.
   0xFFFF: indicates that this Journaline service carries emergency information and that this JML object is the dedicated entry page; see clause
   7.2.8 Support for Emergency Warning Functionality (EWF)” for details
Object type: this 3-bit value indicates the type of JML object:
   000: reserved.
   001: Menu object.
   010: Plain Text message.
   011: Title-Only message.
   100: List message.
   101: reserved.
   110: reserved.
   111: reserved.

The receiver shall ignore JML objects with unknown object Type.

Static flag: this 1-bit value indicates whether the content provided with this object ID is static and therefore the type of content will remain the same in future. If a JML object is signalled as static, the user may be allowed to set a favourite (bookmark link) to this object ID for immediate access in future:
0: random type of content, user must not be allowed set a Favourite (bookmark link) to this temporary object ID.
1: type of content will remain static in future, user may set a Favourite (bookmark link) to this static object ID.

Compress flag: this 1-bit value indicates whether the content section is compressed:
0: Content section is uncompressed.
1: Content section is compressed.

If the content section is compressed, an extra 1-byte value is inserted between the header section and the compressed content section data indicating the compression method.

FIG. 11 illustrates a JML object with compressed content section according to an embodiment.

The compression method value can take the following values:
0x08: deflate compression method as specified, with a fixed window size of 4 096 bytes.
All other values are reserved.

The receiver shall ignore JML objects with an unknown compression method being signalled.

Revision index: this 3-bit unsigned integer value is incremented by 1 (modulo 8) whenever the JML object's content changes.

### 5.3 Content Section

The content section of a JML object contains text information to be presented on screen, and may contain escape sequences to implement extended functionality.

### 5.3.2 Escape Sequences

A JML object's content section may carry any number of escape sequences to introduce text formatting information and rendering hints (e.g. highlighted text, preferred line breaks, etc.) as well as additional functionality.

A receiver is free to evaluate the content and meaning of escape sequences. If a receiver is not able to interpret the content or meaning of a certain escape sequence, it shall ignore the full escape sequence.

Every escape sequence consists of at least the 1-byte escape sequence code, which describes the type of escape sequence. Some escape sequences consist of multiple bytes. Therefore a receiver must be able to at least determine and ignore the total length of every escape sequence.

The following escape sequence codes are currently defined. All other escape sequence code values are reserved for future definition.

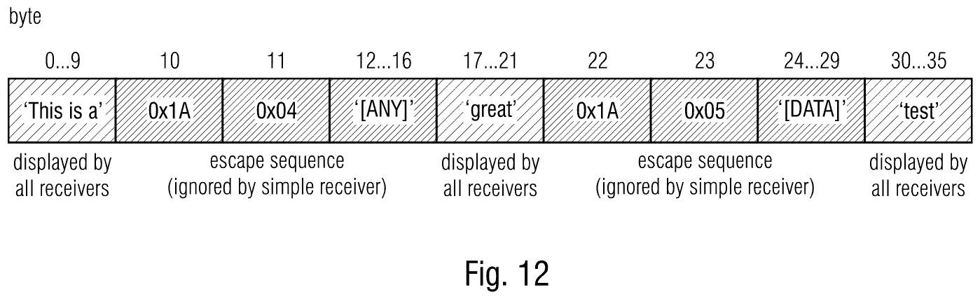

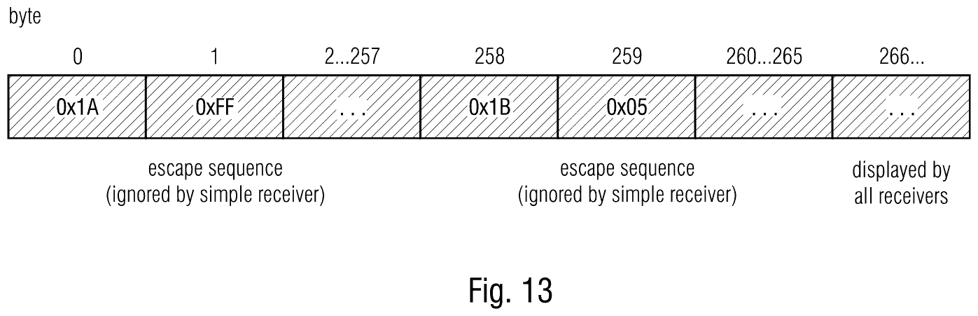

TABLE 2
Escape sequence code definitions

| ESC code | Name | Description |
|---|---|---|
| 0x1A | Data section | These escape sequence codes specify a data section |
| | start | within the visual text that shall not be rendered by a |
| 0x1B | Data section | Journaline receiver that is not capable of evaluating the |
| | continuation | data section. A data section may for instance be inserted |
| | | to provide advanced signalling or any amount of binary |
| | | data. |
| | | Each of these two codes is followed by 1 byte specifying |
| | | the length of the following data section (up to 256 bytes) |
| | | as an unsigned integer with the value |
| | | (<number of bytes> − 1). |
| | | Example text with inserted non-printable information: |
| | | “This is a [ANY]great[DATA] test!” |
| | | Expected visual representation: |
| | | This is a great test! |
| | | Coding example: see FIG. 12. |
| | | If a data section's payload comprises more than 256 |
| | | bytes, additional data section continuation escape |
| | | sequences are inserted immediately after the data |
| | | section start escape sequence. An additional data section |
| | | continuation code can only be inserted if the previous |
| | | data section block is completely filled with 256 bytes. A |
| | | data section continuation code cannot be inserted |
| | | anywhere else. |
| | | Encoding example for a payload of 262 bytes: see FIG. 13 |
| | | The internal payload data structure is defined in clause |
| | | 5.3.2.2. |
| | | Receivers that cannot evaluate a data section's content |
| | | must ignore the whole escape sequence. |

### 5.3.2.1 Escape Sequence ‘Extended Codes’

TABLE 3
Extended code definitions

| | | | |
|---|---|---|---|
| | | | Includes |
| Extended | | | an “end” |
| code | Name | Description | version |

| | | |
|---|---|---|
| 0x00 to | reserved for future definition | — |
| 0xFF | | |

### 5.3.2.2 Escape Sequence “Data Section” Structure and Content

Data sections are special multi-byte escape sequences that allow the insertion of extended signalling or binary data to an object's content section, while ensuring full backwards compatibility to any Journaline receiver that cannot interpret the Data section's content. Data sections shall completely be discarded by a receiver if it cannot interpret their content. This clause describes the general and type specific structure of information that can be carried in a Data section.

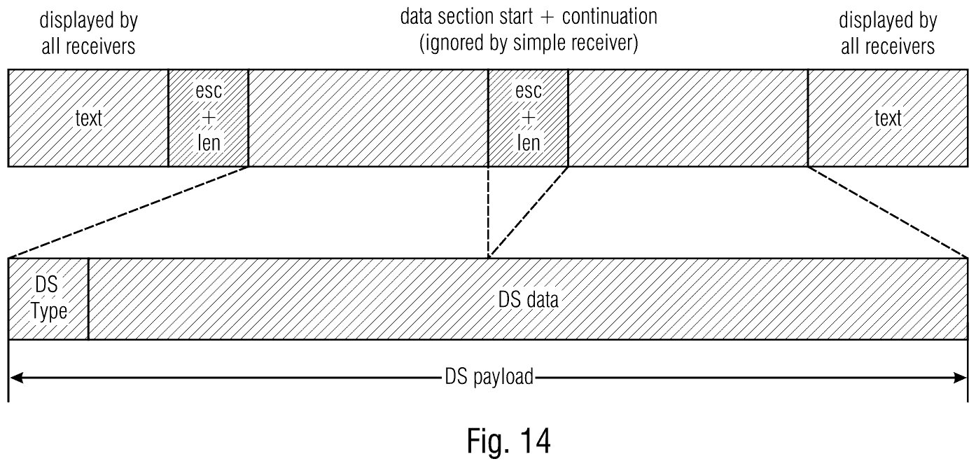

FIG. 14 illustrates data sections and a payload structure according to an embodiment.

The “DS payload” is the combined content of the “data section start” and all immediately following “data section continuation” escape sequences. It has the following structure:
DS type 8 bits.
DS data n×8 bits.

The following definitions apply:

DS type: this 8-bit field identifies the type of content carried in the DS data section.

DS data: this n-Byte field carries the useful information. Its structure and meaning is defined by the DS type parameter.

The following OS types are currently defined. All other DS type values are reserved for future definition.

TABLE 4
DS type definitions

| | | | |
|---|---|---|---|
| DS | | | Location in |
| type | Name | DS data description | content section |

JML object management types:

| | | | |
|---|---|---|---|
| 0x04 | JML object | Indicates that this JML object contains | maximum one |
| | filtering by | information that is only relevant for a subset | before first |
| | tagging | of Journaline decoders. A Journaline decoder | visual text |
| | | may check an internally stored list of tagging | character |
| | | strings against the case sensitive filter strings | |
| | | specified in this JML object. If none of the | |
| | | comparisons match, this JML object shall be | |
| | | ignored. | |
| | | The format and meaning of supported tagging | |
| | | and filter strings are defined for the Journaline | |
| | | encoder and Journaline decoders/special | |
| | | receivers by the respective use-case. | |
| | | The content of this data section contains one | |
| | | or more filter strings. Multiple filter strings are | |
| | | sperated by one 0x00 byte. | |
| | | Each filter string must comprise at least one | |
| | | non-0x00 character. | |
| | | The following wildcard characters may be | |
| | | used (multiple times and at any position within | |
| | | a filter string): ‘?’ represents exactly one | |
| | | character, ‘*’ represents any number (including | |
| | | zero) of characters. | |
| | | Two wildcard characters within a filter string | |
| | | must be separated by at least one non- | |
| | | wildcard character. Wildcard characters are | |
| | | not available as regular characters in filter | |
| | | strings. | |
| | | For a successful comparison, a tagging string | |
| | | must match exactly one of the filter strings; for | |
| | | substring matching, wildcards must be | |
| | | inserted at the beginning and/or end of the | |
| | | filter string. | |
| | | For example, the filter string “954a” ist NOT | |
| | | matched by tagging strings “954A”, “954”, | |
| | | “954ab” or “x954a”. However, all those tagging | |
| | | strings would match the filter string “*954*”. | |
| 0x05 | Content | Allows the Journaline decoder to | any number, |
| | signature | validate/authenticate this JML object. The | anywhere |
| | | Content signature DS carries an issuer ID | |
| | | (defined by the service provider), followed by | |
| | | an issuer-specific data field (signature value). | |
| | | The Journaline decoder must ignore this data | |
| | | section if the issuer ID value does not fully | |
| | | match any of its supported issuer IDs. If an | |
| | | issuer-specific data field is present, it is | |
| | | separated from the issuer ID by a 0x00 byte. | |
| | | The format and algorithm to calculate the | |
| | | signature value (if any) as well as the scope | |
| | | for its calculation (within the un-compressed | |
| | | JML object) must be defined with each issuer | |
| | | ID value. | |
| | | As a very simple example, the issuer ID could | |
| | | be the string “my-MD5-AES”, while the | |
| | | associated issuer-specific data field (signature | |
| | | value) carries the AES encrypted MD5 value | |
| | | checksum in binary form, calculated over the | |
| | | JML object header and JML content section | |
| | | up to this Content signature element. | |

Location reference types:

| | | | |
|---|---|---|---|
| 0xB0 | Latitude/ | Defines a range of positions as | maximum one |
| | longitude | latitude/longitude value pairs. Each value pair | before first |
| | positions | describes one position reference of the JML | visual text |
| | | object. At least one position reference (value | character |
| | | pair) must be defined. | |
| | | A latitude value is specified as a 24-bit 2's | |
| | | complement integer number, in 1/92000^{th} | |
| | | degrees between −90.0 degrees (south pole) | |
| | | and +90,0 degrees (north pole) (leading to a | |
| | | granularity of ca. 2.4 m). | |
| | | A longitude value is specified as a 24−bit 2's | |
| | | complement integer number, in 1/46000^{th} | |
| | | degrees between −180.0 degrees (west) | |
| | | and +180.0 degrees (east) (leading to a maximum | |
| | | granularity of ca. 2.4 m). | |
| | | A position's longitude value immediately | |
| | | follows the position's latitude value. Additional | |
| | | position references immediately follow the | |
| | | previous position references. | |
| 0xB1 | Latitude/ | Defines a region reference for the JML object. | any number |
| | longitude | The region definition is described as a polygon | before first |
| | regions | built from at least 3 latitude/longitude value | visual text |
| | | pairs. Each value pair shall be formatted as | character |
| | | described for DS type “0xB0: | |
| | | Latitude/longitude positions”. | |
| | | For completion of the polygon, the last position | |
| | | (value pair) in the list is connected with the | |
| | | first one. | |
| | | If the absolute longitude value difference of | |
| | | two successive position references is larger | |
| | | than 180 degrees, it shall be assumed that | |
| | | the ±180 degree meridian was crossed. | |
| 0xB2 | Position/ | Contains one or more text labels explaining | maximum one |
| | region | the positions and region definitions (DS types | before first |
| | labels | 0xB0 and 0xB1) to the user. Recommended | visual text |
| | | particularly if multiple positions/regions are | character |
| | | provided for a single JML object (e.g. “Concert | |
| | | entrance”, “Concert parking lot”, “Closest | |
| | | subway station”). | |
| | | Each label is formatted like any visible text in | |
| | | the JML object and may contain escape | |
| | | sequences. | |
| | | Multiple labels are separated by one 0x00 | |
| | | byte. Labels for some positions/regions may | |
| | | be empty, but at least one label must contain | |
| | | at least one visible text character. | |
| | | Each label refers to the position/region | |
| | | definition (from DS type 0xB0 and 0xB1 | |
| | | elements) in the same order as they appear in | |
| | | the JML object. If more labels than | |
| | | positions/regions are defined, excess labels | |
| | | are ignored; if more positions/regions than | |
| | | labels are defined, the remaining labels are | |
| | | considered to be empty. | |
| 0xB3 | JML object | Indicates that this JML object contains | any number |
| | filtering by | information that is only relevant within the | before first |
| | latitude/ | specified geographical region(s). Location- | visual text |
| | longitude | aware Journaline decoders shall ignore this | character |
| | region | JML object if they are not within any of the | |
| | | regions specified for this JML object by DS | |
| | | type 0xB3 elements. | |
| | | The content formatting is identical to DS type | |
| | | 0xB1: “Latitude/longitude regions”. | |
| | | In addition the following restrictions shall | |
| | | apply: A maximum of 32 latitude/longitude | |
| | | value pairs shall be used. Labels according to | |
| | | DS type 0xB2: “Position/region labels” are not | |
| | | applicable. | |

Media reference types:

| | | | |
|---|---|---|---|
| 0xC0 | Image | Defines a reference to an image file to be | anywhere |
| | reference | presented to the user along with the textual | |
| | | content of a JML object. If applicable to a | |
| | | receiver at all, then at least the image formats | |
| | | JPG, PNG and SVG shall be supported. | |
| | | A detailed description is given in clause | |
| | | 5.3.2.4. | |
| | | A JML object may reference multiple images, | |
| | | e.g. to illustrate different sections of a Plain | |
| | | text message, or to label list items of a List | |
| | | message or a Menu object. | |
| 0xC1 | Style | Defines a reference to a ‘Journaline style | any number |
| | reference | folder’. This optional information can be used | before first |
| | | to improve the visual style of HTML based | visual text |
| | | rendering by use of CSS and JavaScript files, | character |
| | | and related content. Each JML object can | |
| | | reference a different style, e.g. to address the | |
| | | type of content (e.g./weather/sunny with a | |
| | | fitting background icon) or the content source | |
| | | (e.g. a news agency with its specific UI). | |
| | | A detailed description is given in clause | |
| | | 5.3.2.5. | |
| | | If multiple Style references are contained in a | |
| | | JML object, the Journaline decoder shall be | |
| | | able to identify the relevant one(s) by format | |
| | | and content. | |

### 5.3.2.3 Data Section “General Link Target” Structure and Content

### 5.3.2.4 Data Section “Image Reference” Structure and Content

The data section's DS type value 0xC0 defines an image reference, i.e. a reference to an image file that may be presented along with the JML object's textual content if supported by a receiver. Image references may be defined for all types of JML objects.

The image should be presented at the location where the image reference is contained in the text information.

If a Journaline receiver is capable of decoding and presenting images, at least the image file formats JPG, PNG and SVG should be supported. It is recommended that the PNG-backward-compatible animation format APNG is supported as well; a Journaline receiver that can decode PNG but not APNG files will still present the first slide of the animation as a regular PNG image.

A JML object may reference multiple images, e.g. to illustrate different sections of a Plain text message, or to label items of a Menu object or rows or tab fields of a List message. Optionally the positioning of images can be specified relative to the location of the image reference within the JML object.

The DS data section “image reference” has the following format:
Link type 8 bits.
Link address length n, 16 bits.
Link address n×8 bits.
Image caption length m, 8 bits.
Image caption m×8 bits.

Additional information may be contained at the end of the link reference after the Image captioning section. Receivers must ignore this information.

The following definitions apply:

Link type: this 8-bit value defines the type of the image reference and thus the format of the Link address field and optionally the remaining DS data section format. The following link type values are currently defined.

TABLE 6
Link type definitions

| Link type | | |
|---|---|---|
| value | Description | Link address format |
| 0x00 | Local | The Link address field carries a reference to an image |
| | | file that is locally available in the receiver, typically a |
| | | folder/file name (useful for specific applications/solutions, |
| | | demos, development, debugging, etc.); the image |
| | | content may have been pre-loaded to the receiver, |
| | | cached in a specific location, or made available by the |
| | | user on external memory devices. |
| 0x01 | Radio-URI | The Link address field carries a URI string pointing to |
| | | image files carried in another service component within |
| | | the same or another DAB/DRM multiplex; the format of a |
| | | Radio-URI is explained in Annex A. |
| 0x02 | URL | The Link address field carries the Internet URL of an |
| | | online image file. |
| 0x03 | Embedded | The Link address field carries a full image file in binary |
| | | form, along with the mime type indicator. It has the |
| | | following format: |
| | | 1 byte: length n of the following mime type indicator |
| | | string in bytes; |
| | | n bytes: mime type indicator string; |
| | | m bytes: binary representation of image file. |

All other values are reserved for future definition.

Image references with unknown or unsupported link type value must be ignored by a receiver.

Link address length: this 16-bit unsigned numeric value (most significant bit first) indicates the length n of the following Link address parameter in bytes. n must not be 0.

Link address: this n-byte field carries the address of the Image reference. If not defined otherwise, all textual address values shall use UTF-8 character encoding. Image caption length: this 8-bit unsigned numeric value indicates the length of the following Image caption parameter in bytes. m may be 0 if no Image caption text shall be provided along with the image.

Image caption: this m-byte field carries the optional image caption as visual text using UTF-8 character encoding (optionally including further escape sequences). If provided, the image caption should be presented as a descriptive text or sub-title associated with the image. If image rendering is not supported by a receiver, it may still present the image caption.

For Embedded images (Link type value 0x03), the following definitions apply:

The Mime type indicator field carries the mime type indicator for the embedded image as a UTF-8 encoded lowercase text string. If applicable, the leading ‘image/’ part of the official mime type string shall be suppressed: the mime type ‘image/png’ will therefore be represented by the lowercase UTF-8 characters ‘png’, the mime type ‘image/jpeg’ as ‘jpeg’.

For the transport of SVG graphics as an embedded image in Journaline, any compressed source SVG file (e.g. ‘.svgz’) must first be uncompressed. When embedded into the JML object, the uncompressed SVG file must be compressed using the deflate compression method as specified in [6] with a fixed window size of 4 096 bytes (i.e. the same compression mechanism available for the JML object's content section). The associated Mime type indicator field value for SVG graphics compressed using this deflate method shall be ‘x-svgx’. (The official mime type for SVG graphics is ‘image/svg+xml’. However, the official mime type is ambiguous: An optional gzip compression is not detectable for receivers through a dedicated mime type, as such compression is performed on transport layer (e.g. HTTP compression or file name extension ‘.svgz’).) NOTE: Embedded SVG images may also use the Mime type values ‘svg+xml’ and ‘x-svgz’ for uncompressed and gzip-compressed SVG images, respectively. However, support for those image formats in the receiver is optional.

SVG files compressed with the Journaline-specific mechanism described above for embedded images shall also be supported by receivers when referenced using one of the other Link type values. In that case, the file extension shall be ‘.svgx’.

### 5.3.2.5 Data Section “Style Reference” Structure and Content

The data section's DS type value 0xC1 defines a style reference, i.e. a reference to a ‘Journaline style folder’. This optional information can be used to improve the visual style of HTML based rendering by use of CSS and JavaScript files, and related content. Each JML object can reference a different style, e.g. to address the type of content (e.g. /weather/sunny with a fitting background icon) or the content source (e.g. a news agency with its specific UI).

The ‘Journaline style folder’ contains a CSS file named ‘j.css’ plus optionally a JavaScript file named ‘j.js’, along with additional required media files (such as background images). These files are typically carried in a ‘JFT’ service component transmitted in the same multiplex as the Journaline service component. JFT, the Journaline File Transmission application type, is dereived from the TFT application type (MOT based Transparent File Transmission) following certain rules.

The ‘j.css’ file carries CSS style definitions, allowing to overwrite the default format of any HTML element of the rendered JML object; it may also reference additional files (such as images or external CSS files). The ‘j.js’ file carries JavaScript that is executed automatically after the Jouranline page is fully loaded into the HTML renderer, and allows to perform optimizations or individualizations based on the HTML elements or the JSON style management information.

Style references may be defined for all types of JML objects. At most one style reference can be defined per JML object.

The DS data section “style reference” has the following format:
Style address type 8 bits.
Style address length n, 16 bits.
Style address n×8 bits.

Additional information may be contained at the end of the style reference after the Style address field. Receivers must ignore this information.

The following definitions apply:

Style address type: this 8-bit value defines the type of the style reference and thus the format of the Style address field and optionally the remaining fS data section format. The following link type values are currently defined.

TABLE 7
Style type definitions

| Style address | | |
|---|---|---|
| type value | Description | Style address format |
| 0x00 | Local | The Style address field carries a reference to a |
| | | Journaline style folder (useful for demos, development, |
| | | debugging, etc.); the content of the referenced |
| | | Journaline style folder has been pre-loaded to the |
| | | receiver, cached in a specific location, or made available |
| | | by the user on external memory devices. |
| 0x01 | Radio-URI | The Style address field carries a URI string pointing to a |
| | | JFT service component in the same DAB/DRM multiplex |
| | | as the Journaline service component, plus a specific |
| | | sub-folder within the JFT service component; the URI |
| | | type identifier is omitted; the format of the DAB-/DRM- |
| | | URI is explained in Annex A |
| 0x02 | URL | The Style address field carries the Internet URL of an |
| | | online folder, which contains at least the j.css file and |
| | | optionally the j.js file. |
| 0x03 | Embedded | The Style address field carries the CSS content |
| | | representing the j.css file, followed optionally by the |
| | | JavaScript content representing the j.js file; if the |
| | | JavaScript content is present, it is separated from the |
| | | CSS content by a single byte of value 0x00; the content |
| | | is provided in UTF-8 format. |
| 0x04 | Style ID | An ID string that uniquely identifies the style to be |
| | | applied for this JML object by the Journaline decoder in a |
| | | way that the target device can interpret, without referring |
| | | to a specific folder or file. For example, the target device |
| | | could use the Style ID string to reference a style-specific |
| | | subfolder, which in turn may carry CSS file(s), Javascript |
| | | file(s) and related media data. |
| | | The Style ID string should not include characters that a |
| | | file systems may not allow for file or folder names, such |
| | | as “/”, “\”, “:” etc. |

All other values are reserved for future definition.

Style type definitions with unknown or unsupported Style address type value must be ignored by a receiver.

Style address length: this 16-bit unsigned numeric value (most significant bit first) indicates the length n of the following Style address parameter in bytes. n must not be 0.

Style address: this n-byte field carries the address of the Style reference. If not defined otherwise, all textual address values shall use UTF-8 character encoding.

### 7 Expected Receiver Behavior

Some general rules apply to Journaline compliant receivers.

### 7.1 Mandatory Functionality

Support for the following functionality is a minimum requirement for a Journaline compliant receiver:
The standard header of a JML object must fully be interpreted. If the extended header is present and its content cannot be interpreted, the extended header shall be discarded.
Deflate decompression for the content section must be supported.
If the user activates Journaline and no point of entry is defined by other means (e.g. as part of the user application signalling), the first JML object to be displayed is the root object with object ID 0x0000.
The JML object types menu, plain text message, title-only message and list message must be supported. JML objects with unknown object types must be ignored.
The user can navigate through menus and select any of the provided link items. The receiver replaces the currently presented JML object with the one defined by the link item.
The user can navigate back to previously visited menus.
The user can access the full visual text of any object, e.g. by scrolling. This does not apply to characters that cannot be displayed due to a limited character font.
Unknown escape sequences shall be discarded if their content cannot be interpreted.
If caching of JML objects is supported by a receiver, the timeout rules per JML object and for the whole Journaline service (as defined in the TOC management data) shall apply. If both a relative and an absolute timeout value are defined, the absolute timeout has highest priority and must be obeyed if the receiver can support absolute timeouts.
Journaline object fragmentation is supported (see clause 8.4).
Journaline decoders used in the context of Emergency Warning Functionality (EWF) shall implement the functionality described in clause “
7.2.8 Support for Emergency Warning Functionality (EWF)”.

### 7.2 Recommended Functionality

### 7.2.8 Support for Emergency Warning Functionality (EWF)

Emergency Warning Functionality (EWF) describes a digital radio receiver's capability to instantly alert affected people nearby in cases of pending and ongoing disasters. This includes the receiver's ability to detect an active emergency alarm and automatically switch to the indicated emergency programme, or even wake-up from standby mode. The emergency programme typically consists of high-level audio announcements and multilingual textual instructions, which are transmitted in Journaline format. The Journaline component is being presented automatically to the user when the emergency programme gets tuned, ready for navigation without extra steps to access it. This advanced text component allows to reach non-native speakers and hearing-impaired users, as well as provide detailed levels of information for on-demand look-up by the user, that would not fit into a high-level audio announcement (such as the regionalized list of shelter locations in cases of incoming Tsunamis).

There are multiple components in the Journaline specification that support this EWF use-case, which should therefore be implemented by a receiver that claims to be EWF compliant.

### 7.2.8.1 Special JML Object-ID Value 0xFFFF

If the Journaline service comprises a JML object with Object-ID 0xFFFF, this indicates that emergency warning related content is available, and the designated object can serve as an entry page to this information.

The emergency programme shall explicitly signal the entry page 0xFFFF as its “Point of entry object ID” as part of its service signalling, allowing a receiver to determine from the service signaling whether or not a transmission carries emergency alarm related Journaline content for an ongoing emergency situation—even in cases where the actual ‘alarm’ announcement signalling is no longer active.

The receiver shall indicate to the user if emergency related Journaline content is broadcast in the currently tuned transmission. The user should be able to easily access this emergency related content, e.g. by pressing a designated button or by clicking on an icon, or via the general service list, where the emergency related content is shown prominently (e.g. as the first entry on the screen, marked as “special” emergency related content). In this case, the label shown in the list shall include the service label of the service that carries the Journaline content. (Note: While it is recommended to have at most one service signalling Journaline's “Point of entry object ID” 0xFFFF per transmission, there could be more than one such service; therefore the user has to be informed about which service the Journaline emergency content belongs to.)

For a Journaline component that is exclusively part of an emergency programme, the legacy default entry page 0x0000 shall be provided in addition to the special entry page 0xFFFF and carry the same content, with 0xFFFF signalled as the “Point of entry object ID”.

In case of a Journaline component shared between different services, the emergency programme shall always signal 0xFFFF as its “Point of entry object ID”, while other services may continue to signal their service-specific entry pages (or default to 0x0000).

### 7.2.8.2JML Object Filtering

There are currently two mechanisms defined to identify JML objects as being particularly relevant to the user: filtering by geographic region and filtering by string tagging. The technical details are described in clause “5.3.2.2 Escape sequence “data section” structure and content” as DS Type 0xB3 “JML object filtering by latitude/longitude region” and DS Type 0x04 “JML object filtering by tagging”, respectively.

In the context of EWF, either or both of these filtering mechanisms shall be used to identify and clearly define the affected area of the emergency or the targeted receivers (or receiver group). Providing this information will allow a consumer receiver to automatically return to the previously tuned service without further user interaction once it is established that the user is not targeted by the active alarm signal, or enable professional receivers such as public screens to determine whether or not the alarm information (or any information page for that matter) is of relevance to them and shall be presented. If technically possible and applicable, the user should also be informed of whether the filtering information provided on a given Journaline page matches his current situation (e.g. by use of an active/inactive ‘relevance’ icon, or through a connected map view).

While the geographic region filtering can be evaluated and acted upon by any location-aware receiver, filtering by string tagging will typically be service-specific and thus defined by the service provider.

In the context of EWF and if relevance information is available on broadcast side, the geographic region definition and/or tagging strings shall be carried as part of the entry page of the emergency programme (“Point of entry object ID” 0xFFFF), and should be carried on any other entry page to this Journaline component (including the default entry page 0x0000).

This mechanism extends with high precision information other means of regionalization of emergency alarms, such as selecting the smallest possible sub-set of transmitters covering the affected area, the proper configuration of service links (such as alarm announcement other ensemble in DAB, regional limitation of the alarm-related AFS list in DRM, etc.), and low-level signaling provided by the respective broadcast standard.

If the emergency programme is presented to the user as a result of automatic service switching or receiver-wake-up due to an active alarm, the receiver shall instantly switch back to the service previously selected by the user once it could determine (with the help of this filtering information) that the alarm is not actually relevant for the user. However, if the user manually selected the emergency programme service or any other service linking to the same Journaline component (e.g. through the regular service list), the filtering information shall not lead to automatic service switching, even though the user may still be informed (e.g. by a button or string) about whether or not the available filtering mechanisms match.

In case of multiple independent emergencies being addressed by the Journaline content simultaneously, the filtering rules shall represent the superset of all incidents. Additional, more specific filtering information may then be provided on the incident-specific menu or page.

Note: To support legacy receivers, the geographic area relevant for an active alarm may in addition to DS type 0xB3 also be presented as a regular region definition via DS type 0xB1 “Latitude/longitude regions” on the Journaline entry page of the emergency programme.

### 7.2.8.3 JML Object Signing

Journaline allows to include a digital signature on any Journaline page, enabling a receiver supporting this mechanism to verify the authenticity and integrity of the provided information. This feature is particularly relevant for public-facing presentation terminals (i.e. public screens), but may also be useful for consumer devices.

Service providers and authorities operating the EWF service in a particular region are highly encouraged to sign critical Journaline pages and to publish the details of the signature mechanism to relevant parties (such as receiver and car manufacturers). The signature shall be based on the DS type 0x05 “Content signature” (see clause “5.3.2.2 Escape sequence “data section” structure and content”), with issuer ID and the format of the signature value defined by the respective service provider.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

In particular, FIGS. 1 to 9 may serve for description of methods, where each block described with respect to an apparatus may represent a step of a method.

Some or all of the method steps may be executed by (or using) a hardware apparatus, like for example, a microprocessor, a programmable computer or an electronic circuit. In some embodiments, one or more of the most important method steps may be executed by such an apparatus.

The inventive digital radio signal can be stored on a digital storage medium or can be transmitted on a transmission medium such as a wireless transmission medium or a wired transmission medium such as the Internet. In other words, further embodiments provide a digital radio signal product including the digital radio signal according to any of the herein described embodiments, e.g. a digital storage medium having stored thereon the digital radio signal.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-10. (canceled)

11. An apparatus for receiving a digital radio signal carrying text-based information content being divided onto information objects, which are broadcasted in a data carousel manner, the apparatus configured to
receive a predetermined information object containing text information;
parse the predetermined information object with checking whether the predetermined information object comprises one or more data sections for supplementing the text information;
if the predetermined information object comprises one or more data sections for supplementing the text information, check one or more indicators of a predetermined data section if the predetermined data section is for supplementing the texture information by an image represented by compressed SVG data;
use a predetermined decompression algorithm for decompressing the text information, and use the predetermined decompression algorithm for decompressing the SVG data.

12. The apparatus according to claim 11, configured to
if the predetermined information object comprises one or more data sections for supplementing the text information, decompress the one or more data section using the predetermined decompression algorithm, and
if the predetermined data section is for supplementing the texture information by an image represented by compressed SVG data, decompress the SVG data using the predetermined decompression algorithm.

13-61. (canceled)

62. An apparatus for receiving a digital radio signal carrying text-based information content being divided onto information objects, which are broadcasted in a data carousel manner, the apparatus configured to
receive a predetermined information object containing text information;
parse the predetermined information object with checking whether the predetermined information object comprises one or more signature data;
if the predetermined information object comprises one or more signature data, check whether a predetermined section of the predetermined information object fits to a predetermined signature data of the one or more signature data in order to verify an integrity and/or an authenticity of the predetermined information object.

63. The apparatus according to claim 62, configure to check, for each signature data, whether the predetermined section of the predetermined information object fits to the respective signature data and confirm the integrity and the authenticity of the predetermined information object if the predetermined section of the predetermined information object fits to the respective signature data.

64. The apparatus according to claim 62, configured to, for each signature data, derive from the respective signature data, a signature issuer ID and a signature value, where the signature ID allows the apparatus to identify and verify if the signature data is supported and relevant, while the associated signature value allows to verify the integrity and authenticity of the predetermined section of the predetermined information object.

65. The apparatus according to claim 62, configured to, for each signature data, derive from the respective signature data, a signature issuer ID and a signature value, wherein the apparatus is configured to use the signature issuer ID to identify a method for verifying the integrity and/or the authenticity of the predetermined section of the predetermined information object, and
verify the integrity and authenticity of the predetermined section of the predetermined information object using the identified method and the signature value.

66. The apparatus according to claim 62, configured to, for at least one of the one or more signature data, derive from the at least one signature data, a location of the predetermined section within the predetermined information object.

67. The apparatus according to claim 62, configured to, for each of the one or more signature data, derive from the at least one signature data, a location of the predetermined section within the predetermined information object so that the location may vary among the one or more signature data.

68.-71. (canceled)

72. An apparatus for receiving a digital radio signal, the digital radio signal comprising a service signal comprising information about a plurality of services signaled in the digital radio signal, wherein the digital radio signal comprises an information service carrying information content being distributed onto information objects, which are broadcasted in a data carousel manner,
wherein each information object comprises an object identifier, and menu information objects comprise links to reference referenced information objects by pointing to the object identifier of the referenced information objects and the apparatus is configured to, based on starting from a start information object being identified by a start object identifier, navigate through information objects and present information obtained from a currently selected information object,
wherein the apparatus is configured to
derive, from the service signal, a set of one or more start object identifiers,
check, whether one of the set of start object identifiers corresponds to a predetermined object identifier.

73. The apparatus according to claim 72, configured to
if one of the set of start object identifiers corresponds to the predetermined object identifier, present an indication indicating a presence of the information object having the predetermined object identifier.

74. The apparatus according to claim 72, wherein the predetermined object identifier is associated with an information object related to an emergency warning and emergency-related information.

75.-77. (canceled)

78. The apparatus according to claim 72, wherein each information object comprises an object ID, and menu information objects comprise links to reference referenced information objects by pointing to the object ID of the referenced information object and the apparatus is configured to, based on starting from a start object ID, navigate through information objects and present to a user information obtained from a currently selected information objects.

79. The apparatus according to claim 78, configured to navigate through information objects by presenting to a user information obtained from a currently selected information objects, and switching to a selected referenced information object.

80. The apparatus according to claim 79, configured to select the selected referenced information object based on user input.

81. The apparatus according to claim 72, wherein the predetermined information object comprises a header section and a data section, the data section containing the text information.

82.-84. (canceled)

85. The apparatus according to claim 11, wherein each information object comprises an object ID, and menu information objects comprise links to reference referenced information objects by pointing to the object ID of the referenced information object and the apparatus is configured to, based on starting from a start object ID, navigate through information objects and present to a user information obtained from a currently selected information objects.

86. The apparatus according to claim 85, configured to navigate through information objects by presenting to a user information obtained from a currently selected information objects, and switching to a selected referenced information object.

87. The apparatus according to claim 86, configured to select the selected referenced information object based on user input.

88. The apparatus according to claim 11, wherein the predetermined information object comprises a header section and a data section, the data section containing the text information.
